(19) United States
(12) Patent Application Publication
(10) Pub. No.: US 2023/0381770 A1
(43) Pub. Date: Nov. 30, 2023

(54) Sample Preparation Cartridge and System

(71) Applicant: Syndex Bio Ltd., Cambridge (GB)

(72) Inventors: Geoff SMITH, Cambridge (GB); Adam LOWE, San Francisco, CA (US); Chris HODSON, Cambridge (GB)

(21) Appl. No.: 17/825,382

(22) Filed: May 26, 2022

(51) Int. Cl. B01L 3/00; B01L 3/02

(52) U.S. Cl. CPC B01L 3/502; B01L 3/021; B01L 3/527; B01L 2300/0877

(57) ABSTRACT

A sample preparation cartridge and sample preparation device where the cartridge comprises a plurality of containers for holding fluid, a first moveable arm, and a second moveable arm. Each moveable arm is configured to transfer fluid from one container of the plurality of containers to another container of the plurality of containers to perform sample preparatory workflows. Preferably, at least a portion of plurality of containers are utilised by both the first moveable arm and the second moveable arm.

### FIELD OF THE INVENTION

The present disclosure relates to a sample preparation system with a sample preparation cartridge.

### BACKGROUND

In the field of diagnostics there is a need to provide sample preparation devices that can be used in the analysis of a sample from a patient. In particular there is a growing need for Point of Care diagnostic devices that enable a sample to be prepared and analysed at the location of the patient to ensure rapid analysis and improve overall care for a patient. Many analytical approaches can be applied to samples, including but not limited to molecular diagnostics, chemical analysis, immunoassays, and flow cytometry. Current systems typically manipulate samples using a predetermined sequential process of fluid manipulation through chambers according to a specific protocol and as such are not very versatile.

There is also a need to provide sample preparation devices and cartridges in the field of material synthesis and preparation, for example including proteins, peptides, nucleic acids, etc, for use in research, translational, and therapeutic applications. This may include sample preparation devices and cartridges for cell free protein synthesis and purification, mRNA synthesis, purification and association with a delivery agent, synthesis and purification of CRISPR cassettes, antibody and peptide discovery and testing, synthesis and purification of viral vector DNA, and/or neoantigen vaccines, to name only a few.

GB 2556835 discloses a sample preparation cartridge for use with a sample preparation device, the cartridge comprising a housing defining plural separate segments, wherein at least one of said segment comprises a fixed section of a pipette component and a moveable pipette arm comprising a pipette tip. The pipette arm is configured to be moved between a position in which the pipette tip is in sealed engagement with the fixed section of pipette component and a position in which pipette tip is positioned adjacent to another of said plural segments. The segments are arranged around a central axis of the housing and the moveable pipette arm is arranged to rotate around the axis and lower towards, or raise from, a desired segment when it has been rotated to be positioned above the desired segment.

### SUMMARY OF THE INVENTION

Aspects of the invention are as set out in the independent claims and optional features are set out in the dependent claims. Aspects of the invention may be provided in conjunction with each other and features of one aspect may be applied to other aspects.

In one aspect of the invention there is provided a sample preparation cartridge for use with a sample preparation device, the cartridge comprising a plurality of containers for holding fluid, a first moveable arm, and a second moveable arm. Each moveable arm is configured to transfer fluid from one container of the plurality of containers to another container of the plurality of containers.

In some examples, each moveable arm may be configured to transfer fluid, analyte, beads, or reagent. The provision of a plurality of moveable arms may be advantageous to introduce greater flexibility and efficiency in the workflow of sample preparation and/or analysis. This may allow a sequence of processing steps to be selected and performed by configuring the series of containers between which a sample is transported. This may also allow more complex workflows to be completed which would not otherwise be possible, for example wherein the plurality of movable arms may conduct processing steps in parallel. Purely for illustrative purposes, one example use of this could be the parallel extraction and purification of DNA and RNA from a biological sample simultaneously, optionally using common reagents where appropriate. The plurality of moveable arms may also be advantageous to reduce contamination of the fluid/sample which may occur by using only one moveable arm, for example the first movable arm may be used for “dirty” sample processing steps, whereas the second moveable arm may be used for “clean” sample processing steps to prevent the sample being contaminated with fluid or reagents from earlier in the process.

The sample preparation cartridge may be used for analysing a fluid sample by separating and holding a desired analyte, for chemical reaction, from a biological fluid sample. For example, in one possible use case, the analyte is nucleic acid, but could also be proteins, carbohydrates, bacteria or parasites. The cartridge may also be capable of processing samples such as blood, saliva, urine, mucus, or other bodily fluids, as well as solid samples or airborne particles suspended in a fluid. Some samples can be input into the cartridge in a raw form, whilst others may be pre-mixed with chemicals, reagents, diluents, or buffers or pre-treated with centrifuge, sonicators, macerators, etc.

For purely illustrative purposes, in one possible use case, when the desired analyte is nucleic acid such as DNA or RNA, the cartridge may separate the nucleic acid from the sample, purify it by washing and then hold it for amplification using PCR. Detection may be achieved using optical or electrochemical methods.

In some examples, the plurality of containers, and optionally the first and second moveable arms may be arranged in a common housing. This may be advantageous to enable fluid to be easily and safely transferred selectively between containers, whilst ensuring sterility and reducing environmental contamination during the workflow. Optionally, the common housing may be hermetically sealed. In some examples, the cartridge may comprise an optional vent with a filtered valve to ensure equalization of pressure between the interior of the sample preparation cartridge and the external atmosphere.

The common housing may comprise a sealable inlet configured to allow access to the interior of the cartridge, for example to insert a sample.

In some examples, the first moveable arm may be configured to rotate around a first axis, and the second moveable arm may be configured to rotate around a second axis. In some examples, at least one of the first axis or second axis is arranged off-centre relative to the common housing. However, in other examples the first moveable arm and the second moveable arm may be configured to rotate around a common axis, for example including wherein the common axis may be arranged off-centre relative to the common housing.

In some examples the plurality of containers may comprise (i) a first portion of containers arranged to be only accessible by the first moving arm; and (ii) a second portion of containers arranged to be only accessible by the second moving arm. This may be advantageous to minimise contamination between containers. For example, the first portion of containers may represent a “dirty” portion for performing dirty sample preparation steps, and the second portion of containers may represent a “clean” portion for performing clean sample preparation steps, such as distillation, purification, or isolation. Purely for illustrative purposes, one example use of the cartridge of the present invention may involve a crude biological sample as input into the cartridge, a workflow utilising the first moveable arm and the first portion of containers may then extract nucleic acid from the sample. The extracted nucleic acid may then be transferred to the second portion of containers to be processed using the second moveable arm without contamination with the original input. Other use examples may include wherein the first portion of containers are used for pre-purification workflow, whilst the second portion of containers are used for post-purification workflow; for example including a workflow with a PCR and post PCR cleanup, or preparation of material including a pre-sterilisation process, and a post-sterilisation process, for example using filter sterilisation. Other specific examples may include but are not limited to Nickel affinity chromatography or buffer exchange through a desalting step.

The plurality of containers may also comprise a third portion of containers arranged to be accessible by both the first moving arm and the second moving arm. This may be advantageous to allow fluid to be passed between the first moveable arm and first portion of containers, and the second moveable arm and the second portion of containers. This may also be advantageous to allow common reagents to be held in the third portion of containers, accessible by both the first and second moveable arm. For example, this may facilitate parallel processing of two samples (for example, a sample and a control) which could occur in the first portion of containers and the second portion of containers simultaneously, and, where appropriate, using common reagents held within the third portion of containers.

The first moveable arm and the second moveable arm may be configured to be rotated and/or operated at least one of (i) independently from one another, (ii) simultaneously, (iii) in parallel, or (iv) in series. Operation of a moveable arm may comprise at least one of (i) raising the moveable arm, (ii) lowering the moveable arm, (iii) creating a region of negative pressure in the moveable arm (aspiration), or (iv) creating a region of positive pressure in the moveable arm (dispensing).

In some examples, the cartridge may comprise a plurality of moveable arms, for example at least three moveable arms. This may be advantageous to enable increasingly complex workflows to be completed with greater flexibility.

Each moveable arm may comprise a cavity configured to support fluid, and a receiving portion, coupled to the cavity, configured to receive fluid from a container into the cavity, or dispense fluid from the cavity into a container.

In some examples, at least one container comprises an engagement portion configured to reversibly engage with the receiving portion of the movable arm. The engagement portion of the container may comprise a first tubular member configured to extend into the at least one container. This may be advantageous to reduce the overall depth of the sample preparation cartridge to keep it small and compact, low cost and easy to handle.

Each moveable arm may be configured to be moved between (i) an engaged configuration, wherein the moveable arm is in sealed engagement with the engagement portion of a container; and (ii) a displaced configuration, wherein the moveable arm is vertically displaced from the plurality of containers. In the engaged configuration, the receiving portion of the moveable arm may form a fluidic seal with the engagement portion container.

In the engaged configuration, fluid may be configured to be drawn from the at least one container through the first tubular member and into the cavity of a moveable arm by aspiration.

In some examples, each moveable arm comprises a pipette. For example, the first tubular member comprises a pipette tip; and the receiving portion of the at least one moveable arm may comprise a second tubular member. In the engaged configuration the second tubular member may be in sealed engagement with the pipette tip.

In some examples, at least one of (i) the second tubular member and (ii) the cavity may be detachable from each moveable arm such that the at least one of (i) the second tubular member and (ii) the cavity may be replaceable. This may be advantageous to reduce contamination as used sections of the moveable arm may be disposed of and replaced. The cartridge may comprise at least one container configured to be a “waste container”, for example wherein the waste container is configured to receive waste including used and discarded sections of a moveable arm.

At least one container of the plurality of containers may be at least partially sealed with a pierceable film or foil. This may be advantageous to preserve the sterility of the container and reduce contamination, including contamination between individual containers during the sample preparation cartridge's handling and/or during use. Optionally, at least one moveable arm may comprise a piercing member, configured to pierce the film or foil seal of the container, such that the moveable arm may access the container.

In some examples, the plurality of containers comprises at least one removable container configured to be detachable from the cartridge. For example, a detachable cuvette, vial, syringe, or other container. Additionally, or instead, the cartridge may comprise a detachable chip, wherein fluid may be dispensed by at least one moveable arm onto a chip, for example a biochip, as part of the workflow. The chip and/or removable container may be detached from the cartridge, for example for sample analysis. This may be advantageous to remove a sample for off-device analysis. Each removeable container may comprise a tubular member, wherein the tubular member may be configured to extract or dispense the sample or fluid contained within the removable container for off-device sample analysis.

In some examples, the at least one removable container and/or chip comprise a sealing member configured to seal the removable container and/or chip when detached from the cartridge. This may be advantageous to maintain sterility and avoid contamination of the fluid or sample once detached from the cartridge. For example, the sealing member may comprise a rubber seal. Optionally, the cartridge may comprise a second sealing member configured to seal the cartridge when the at least one removable container is detached. This may be advantageous to maintain sterility and avoid contamination of the remaining cartridge. For example, the sealing member may comprise a rubber seal.

In some examples, the cartridge may further comprise an alignment feature configured to align the position of the cartridge when the cartridge is inserted within a sample preparation device. For example, the alignment feature may be (i) a moulded element of the common housing; or (ii) a coded tag. This may be advantageous to ensure the cartridge is aligned and/or in the correct orientation for engagement with the drive member when inserted into a sample analysis device. A coded tag may comprise a barcode and/or a RFID chip which may be used by the analysis device to indicate the alignment, orientation, and/or contents of the cartridge, for example including the contents of the plurality of containers.

Optionally, the cartridge may comprise a connector module, configured to transfer fluid from at least one container of the first portion of containers to at least one container of the second portion of containers. This may be advantageous to allow fluid to be passed from at least one of the first portion of containers to at least one of the second portion of containers, whilst reducing contamination of the fluid and/or sample between containers.

The connector module may comprise a first end comprising an inlet, wherein the inlet is configured to receive fluid from at least one container of the first plurality of containers; and a second end comprising an outlet, wherein the outlet is configured to dispense fluid. The connector module may further comprise a cavity configured to permit the flow of fluid from the inlet to the outlet. In some examples, fluid is configured to be drawn into the inlet and out of the outlet of the connector module by aspiration.

The first end of the connector module may be coupled to at least one container of the first portion of containers.

In some examples, the outlet of the connector module may be configured to reversibly engage with the second moveable arm. Additionally, or instead, the second end of the connector module may be coupled to at least one container of the second portion of containers.

Optionally, the common housing may comprise at least one fixed portion, comprising the first and second portion of containers; and a carousel portion, wherein the carousel portion is configured to rotate relative to the fixed portion. The carousel portion may comprise the third portion of containers. This may be advantageous to increase the number of containers accessible by both the first moving arm and the second moving arm.

In some examples, at least one of the first axis or the second axis may be arranged on the at least one fixed portion of the common housing. However, in other examples, the first moveable arm and the second moveable arm may be coupled to the carousel portion and configured to rotate about a common axis, wherein the common axis is the rotational axis of the carousel portion. In such examples, the first moveable arm and the second moveable arm may be fixed relative to each other and configured to be rotatable relative to the plurality of containers.

In another aspect of the invention, there is provided a sample preparation cartridge for use with a sample preparation device, the cartridge comprising a plurality of containers and at least one moveable arm configured to transfer fluid from one container of the plurality of containers to another container of the plurality of containers. The at least one moveable arm is arranged to rotate around an off-centre axis of the cartridge.

In some examples, at least a portion of the plurality of containers may be arranged around the axis of the at least one moveable arm such that the plurality of containers are configured to be accessible by the at least one moveable arm. Optionally, at least two of the containers are configured to hold different volumes, and/or are different sizes, and/or are different depths. This may be advantageous to facilitate flexibility into the sample preparation workflow, wherein at least a portion of the containers may be tailored to the workflow method. For example, at least one container may have a larger volume for holding fluid to act as a reservoir, for example a reservoir of buffer. The shape, size and volume of other containers may be adapted based on their specific use, for example based on the fluid, analyte, beads, or reagent which the container is configured to hold.

In some examples, the plurality of containers may comprise at least one removable container configured to be detachable from the cartridge. For example, a detachable vial, syringe, or other container. Additionally, or instead, the cartridge may comprise a detachable chip, wherein fluid may be dispensed by at least one moveable arm onto a chip, for example a biochip, as part of the workflow. The chip and/or removable container may be detached from the cartridge, for example for sample analysis.

In some examples, the at least one removable container and/or chip comprise a sealing member configured to seal the removable container and/or chip when detached from the cartridge. This may be advantageous to maintain sterility and avoid contamination of the fluid or sample once detached from the cartridge. For example, the sealing member may comprise a rubber seal. Optionally, the cartridge may comprise a second sealing member configured to seal the cartridge when the at least one removable container is detached, for example a rubber seal. This may be advantageous to maintain sterility and avoid contamination of the remaining cartridge.

In some examples, the cartridge may further comprise an alignment feature configured to align the position of the cartridge when the cartridge is inserted within a sample preparation device. For example, the alignment feature may be (i) a moulded element of the common housing; or (ii) a coded tag. This may be advantageous to ensure the cartridge is aligned and/or in the correct orientation for engagement with the drive member when inserted into a sample analysis device. A coded tag may comprise a barcode and/or a RFID chip. Such a barcode and/or RFID chip may be used by the analysis device to indicate the alignment, orientation, and/or contents of the cartridge, for example including the contents of the plurality of containers.

In some examples, the at least one moveable arm is arranged to rotate around the off-centre axis of the housing such that the moveable arm may be configured to transfer fluid from a container of the plurality of containers to a container in an adjacent housing. This may be advantageous to facilitate complex workflows between multiple housings, and/or reduce contamination, for example by having a “dirty” housing for dirty sample preparation steps, and a “clean” housing for clean sample preparation steps, for example isolation, distillation, purification, sterilisation. The ability to transfer fluid from a container of the plurality of containers to a container in an adjacent housing may also be advantageous to tailor the sample preparation workflow based on a modular approach. For example, a selection of housings may be interchanged, wherein each housing is configured for a different sample preparation workflow, method, or process. Different housings may comprise a different plurality of containers, for example comprising at least one different fluid, analyte, beads, or reagent. Thus, by selecting at least a first housing and a second housing, a tailored workflow may be created.

In some examples, the cartridge comprises a plurality of moveable arms.

In another aspect of the invention, there is provided a sample preparation cartridge for use with a sample preparation device, the cartridge comprising a first housing and a second housing. The first housing comprises a first plurality of containers and at least a first moveable arm configured to transfer fluid from one container of the first plurality of containers to another container of the first plurality of containers. The second housing comprises a second plurality of containers and at least a second movable arm configured to transfer fluid from one container of the second plurality of containers to another container of the second plurality of containers. At least one of the first moveable arm or the second moveable arm is arranged to transfer fluid from a container of the first plurality of containers to a container of the second plurality of containers. This may be advantageous to facilitate complex workflows between multiple housings, and/or reduce contamination, for example by having a “dirty” housing for dirty sample preparation steps, and a “clean” housing for clean sample preparation steps, for example isolation, distillation, purification. The ability to transfer fluid from a container of the plurality of containers to a container in an adjacent housing may also be advantageous to tailor the sample preparation workflow based on a modular approach. For example, a selection of housings may be interchanged, wherein each housing is configured for a different sample preparation workflow, method, or process. Different housings may comprise a different plurality of containers, for example comprising at least one different fluid, analyte, beads, or reagent. Thus, by selecting at least a first housing and a second housing, a tailored workflow may be created.

In some examples, at least a portion of the first plurality of containers are arranged to be accessible by both the first moveable arm and the second moveable arm. In some examples, at least a portion of the second plurality of containers are arranged to be accessible by both the first moveable arm and the second moveable arm. In some examples, at least a portion of the first plurality of containers and at least a portion of the second plurality of containers are arranged to be accessible by both the first moveable arm and the second moveable arm.

In some examples, the first moveable arm may be configured to rotate around an axis of the first housing and the second moveable arm may be configured to rotate around an axis of the second housing. At least one of the first axis or second axis may be arranged off-centre relative to the respective housing.

Each moveable arm may comprise a cavity configured to support fluid. Each moveable arm may further comprise a receiving portion, coupled to the cavity. The receiving portion may be configured to receive fluid from a container into the cavity or dispense fluid from the cavity into a container. In some examples, each moveable arm comprises a pipette, or at least a portion thereof.

In some examples, at least one container comprises an engagement portion configured to reversibly engage with a movable arm, for example wherein the engagement portion is configured to reversibly engage with the receiving portion of a movable arm.

Each moveable arm may be configured to be moved between (i) an engaged configuration, wherein the moveable arm is in sealed engagement with the engagement portion of a container; and (ii) a displaced configuration, wherein the moveable arm is vertically displaced from the plurality of containers. In the engaged configuration, the receiving portion of the moveable arm may form a fluidic seal with the engagement portion of the container.

In some examples, the engagement portion may comprise a first tubular member configured to extend into the at least one container. The first tubular member may be fixed to the container. In some examples, the first tubular member may be cylindrical or conical, however the skilled person will understand that other tubular shapes may be used. The first tubular member preferably has a high aspect ratio. This may be advantageous to transfer fluid by capillary action through the first tubular member. In some examples, the first tubular member may be a fixed pipette tip.

Fluid may be configured to be drawn from the at least one container through the first tubular member and into the cavity of the first or second moveable arm by aspiration.

In some examples, the receiving portion of at least one moveable arm comprises a second tubular member. In the engaged configuration, the second tubular member is configured to form a sealed engagement with the first tubular member of the container. For example, the sealed engagement may be formed wherein the second tubular member fits concentrically within the first tubular member, or vice versa. Alternatively, or in addition, at least one of the first tubular member and the second tubular member may comprise a sealing washer.

In some examples, at least one of (i) the second tubular member and (ii) the cavity may be detachable from each moveable arm such that the at least one of (i) the second tubular member and (ii) the cavity may be replaceable. This may be advantageous to remove used and contaminated sections of the moveable arm to reduce contamination of fluid.

The cartridge may further comprise a common cartridge housing, wherein the common cartridge housing comprises a first receiving portion configured to receive the first housing, and a second receiving portion configured to receive the second housing. This may be advantageous to reduce contamination and improve sterility of the environment.

The separation between the first receiving portion and the second receiving portion of the common cartridge housing may be a function of the length of the at least one moveable arm arranged to transfer fluid from a container of the first plurality of containers to a container of the second plurality of containers. This may be advantageous such that at least one of the first moveable arm or the second moveable arm is configured to transfer fluid from a container of the first plurality of containers to a container of the second plurality of containers.

At least one of the first or second housings may be configured to at least partially bound at least a portion of the other housing, for example wherein (i) at least a portion of the first housing is configured to partially bound at least a portion of the second housing, or (ii) at least a portion of the second housing is configured to partially bound at least a portion of the first housing. This may be advantageous to reduce the size of the cartridge, for example facilitating a housing to be inset, nested, or tessellated relative to another.

In some examples, the first housing and the second housing are coupled, for example by an interlocking structure and/or mechanism.

In another aspect of the invention, there is provided a sample preparation cartridge for use with a sample preparation device. The cartridge comprises at least one fixed portion, a carousel portion, and at least one moveable arm. The carousel portion is configured to rotate relative to the fixed portion. The fixed portion comprises a first portion or plurality of containers; and the carousel portion comprises a second plurality or portion of containers. The at least one moveable arm is configured to transfer fluid from one container of the first or second plurality of containers to another container of the first or second plurality of containers. This may be advantageous to increase the number of containers within reach of the moveable arm, enabling more complex workflows.

For example, the at least one moveable arm may be configured to transfer fluid at least one of (i) from a container of the carousel portion to a container of the fixed portion; (ii) from a container of the fixed portion to a container of the carousel portion; (iii) from one container of carousel portion to another container of carousel portion; and (iv) from one container of fixed portion to another container of fixed portion.

In some examples, the fixed portion partially bounds the carousel portion. This may be advantageous to reduce the size of the cartridge.

In some examples, the cartridge may further comprise at least a second moveable arm. The first plurality of containers, arranged on the fixed portion of the cartridge, may then comprise (i) a portion of first plurality of containers arranged to be accessible only by the first moving arm; and (ii) a portion of the first plurality of containers arranged to be accessible only by the second moving arm. The second plurality of containers, arranged on the carousel portion, may be arranged to be accessible by both the first moving arm and the second moving arm.

In some examples, the cartridge may comprise a plurality of moveable arms, for example at least three moveable arms. This may be advantageous to facilitate more complex workflows being performed in the cartridge.

Each moveable arm may comprise a cavity configured to support fluid. Each moveable arm may further comprise a receiving portion, coupled to the cavity. The receiving portion may be configured to receive fluid from a container into the cavity or dispense fluid from the cavity into a container. In some examples, each moveable arm comprises a pipette, or at least a portion thereof.

In some examples, at least one container comprises an engagement portion configured to reversibly engage with a movable arm, for example wherein the engagement portion is configured to reversibly engage with the receiving portion of a movable arm.

Each moveable arm may be configured to be moved between (i) an engaged configuration, wherein the moveable arm is in sealed engagement with the engagement portion of a container; and (ii) a displaced configuration, wherein the moveable arm is vertically displaced from the plurality of containers. In the engaged configuration, the receiving portion of the moveable arm may form a fluidic seal with the engagement portion of the container.

In some examples, the engagement portion may comprise a first tubular member configured to extend into the at least one container. The first tubular member may be fixed to the container. In some examples, the first tubular member may be cylindrical or conical, however the skilled person will understand that other tubular shapes may be used. The first tubular member preferably has a high aspect ratio. This may be advantageous to transfer fluid by capillary action through the first tubular member. In some examples, the first tubular member may be a fixed pipette tip.

Fluid may be configured to be drawn from the at least one container through the first tubular member and into the cavity of the first or second moveable arm by aspiration.

In some examples, the receiving portion of at least one moveable arm comprises a second tubular member. In the engaged configuration, the second tubular member is configured to form a sealed engagement with the first tubular member of the container. For example, the sealed engagement may be formed wherein the second tubular member fits concentrically within the first tubular member, or vice versa. Alternatively, or in addition, at least one of the first tubular member and the second tubular member may comprise a sealing washer.

In some examples, at least one of (i) the second tubular member and (ii) the cavity may be detachable from each moveable arm such that the at least one of (i) the second tubular member and (ii) the cavity may be replaceable. This may be advantageous to remove used and contaminated sections of the moveable arm to reduce contamination of fluid.

In another aspect of the invention, there is provided a sample preparation cartridge for use with a sample preparation device, wherein the cartridge comprises a first housing comprising a first plurality of containers for holding fluid, and a second housing comprising a second plurality of containers for holding fluid. The cartridge further comprises a connector module, configured to transfer fluid from at least one container of the first plurality of containers to at least one container of the second plurality of containers. In some examples, at least one of the first housing and the second housing may comprise at least one moveable arm configured to transfer fluid from at least one container of the first or second plurality of containers to at least another container of the same plurality of containers.

The connector module may be configured to couple the second housing to the first housing.

The connector module may comprise a first end comprising an inlet, a second then comprising an outlet, and a cavity, coupled to the inlet and to the outlet. The inlet is configured to receive fluid from at least one container of the first plurality of containers, and the outlet is configured to dispense fluid. The cavity is configured to permit the flow of fluid from the inlet to the outlet.

Fluid may be configured to be drawn into the inlet and out of the outlet by aspiration.

The at least one moveable arm may comprise a cavity configured to support fluid and a receiving portion, coupled to the cavity, configured to receive fluid from a container into the cavity, or dispense fluid from the cavity into a container.

In some examples, the outlet of the connector module is configured to reversibly engage with the at least one moveable arm, preferably wherein the second housing comprises the at least one moveable arm. The outlet of the connector module may be configured to reversibly engage with the receiving portion of the movable arm.

The at least one moveable arm may be configured to be moved between at least (i) an engaged configuration, wherein the moveable arm is in sealed engagement with the outlet of the connector module; and (ii) a displaced configuration, wherein the moveable arm is displaced from the connector module. In the engaged configuration, the receiving portion of the moveable arm may form a fluidic seal with the outlet of the connector module. The at least one movable arm may also be configured to be moved between (iii) an engaged configuration, wherein the moveable arm is in sealed engagement with a container, for example a fluidic seal; and (iv) a displaced configuration, wherein the moveable arm is displaced from the container.

Fluid may be configured to be drawn out of the outlet of the connector module and into the cavity of the at least one moveable arm by aspiration.

The first end of the connector module may be coupled to at least one container of the first plurality of containers, for example, by a snap fit.

The first end of the connector module may comprise at least one tubular member, for example a nozzle, configured to extend into a container of the first plurality of containers. The tubular member preferably has a high aspect ratio.

The connector module may further comprise a one-way valve configured to prevent the flow of fluid from the outlet to the inlet.

The connector module may optionally comprise a matrix, for example arranged within the cavity of the connector module. The matrix may be configured to perform a specific function on the fluid, beyond solely fluid transfer. For example, the cavity of the connector may comprise a desalting matrix configured to desalt fluid as it is transferred from the inlet of the connector module to the outlet.

At least one container of the first plurality of containers may be at least partially sealed with a pierceable film or foil. This may be advantageous to preserve the sterility of the container and reduce contamination, including contamination between individual containers during the sample preparation cartridge's handling and/or during use. Optionally, the first end of the connector module further comprises a piercing member, configured to pierce the film or foil seal of the container, such that the first end of the connector module may access the container.

In some examples, the first housing, the second housing and the connector module are arranged in a common housing. This may be advantageous to maintain sterility and reduce contamination. Optionally, the common housing may be hermetically sealed.

In some examples, the first housing may be a first sample preparation cartridge and the second housing may be a second sample preparation cartridge, for example such as but not limited to any of the sample preparation cartridges of the other aspects of the invention disclosed herein. The first cartridge, second cartridge, and connector module may or may not be arranged in a common housing.

In some examples, the plurality of containers comprises at least one removable container configured to be detachable from the cartridge. For example, a detachable vial, syringe, or other container. Additionally, or instead, the cartridge may comprise a detachable chip, wherein fluid may be dispensed by at least one moveable arm onto a chip, for example a biochip, as part of the workflow. The chip and/or removable container may be detached from the cartridge, for example for sample analysis.

In some examples, the at least one removable container and/or chip comprise a sealing member configured to seal the removable container and/or chip when detached from the cartridge. This may be advantageous to maintain sterility and avoid contamination of the fluid or sample once detached from the cartridge. For example, the sealing member may comprise a rubber seal. Optionally, the cartridge may comprise a second sealing member configured to seal the cartridge when the at least one removable container is detached, for example a rubber seal. This may be advantageous to maintain sterility and avoid contamination of the remaining cartridge.

In some examples, the cartridge may further comprise an alignment feature configured to align the position of the cartridge when the cartridge is inserted within a sample preparation device. For example, the alignment feature may be (i) a moulded element of the common housing; or (ii) a coded tag. This may be advantageous to ensure the cartridge is aligned and/or in the correct orientation for engagement with the drive member when inserted into a sample analysis device. A coded tag may comprise a barcode and/or a RFID chip. Such a barcode and/or RFID chip may be used by the analysis device to indicate the alignment, orientation, and/or contents of the cartridge, for example including the contents of the plurality of containers.

In another aspect of the invention, there is provided a sample preparation system comprising a sample preparation cartridge, a pump in fluid communication with the sample preparation cartridge, and at least one drive member configured to engage with the sample preparation cartridge. The sample preparation cartridge comprises a plurality of containers for holding fluid and at least one moveable arm configured to transfer fluid from one container of the plurality of containers to another container of the plurality of containers. The system further comprises a wireless communication interface, coupled to the pump and at least one drive member, configured to communicate with a remote device. This may be advantageous to reduce the computing power and memory required by the system for operation of the pump and at least one drive member. This may have associated benefits including weight reduction, cost reduction, size reduction, and reduced operating power requirements.

The separation of the system into cartridge and instrument comprising a drive member and pump may enable a multitude of different tests, configured within specific cartridges, to be automatically undertaken with a single instrument. These may include but are not limited to PCR (thermally cycled), PCR (isothermal), immunoassay, clinical chemistry, lateral flow, material synthesis, material preparation, and material purification, including cell free protein synthesis, RNA or peptide vaccine manufacture, and many others where samples are transferred, mixed, reacted and/or analysed etc.

The system may further comprise a processor, coupled to the wireless communications interface, the pump, and at least one drive member. The processor may be configured to manage the workflow received by the wireless communication interface. The processor may also be configured to, via the wireless communication interface to the remote device, to manage protocols, updates, troubleshoot, optimisation, etc.

The system may further comprise a heating element. The heating element may be configured to heat at least a portion of the sample preparation cartridge, and at least a portion of the containers therein.

The system may further comprise a magnet.

In some examples, the system further comprises a battery to power the pump and drive shaft, this may be facilitated by the reduced operating requirements associated with the reduced computing power of the system. This may be advantageous to enable the system to be portable and lightweight, facilitating the system being brought into the field, for example for Point of Care sample preparation or analysis. With the present invention, a disposable sample preparation cartridge and corresponding analytical system can be provided in a very cost effective and simple manner whilst still ensuring high quality sample preparation for analysis.

The sample preparation cartridge may be, but is not limited to, any sample preparation cartridge of the previous aspects of the invention disclosed herein.

The at least one drive member may be configured to engage with the at least one moveable arm such that the drive member actuates movement of the moveable arm. For example, the at least one drive member is configured to at least one of (i) raise, (ii) lower, and (iii) rotate, the at least one moveable arm.

The at least one moveable arm may be in fluid communication with the pump.

The wireless communication interface may be configured to receive operation instructions for at least one of (i) the pump and (ii) the drive member, from the remote device, for example a smartphone, tablet, personal computer, or IoT device. Optionally, the wireless communication interface may be configured to receive operations instructions from a remote device via a remote server, or API.

The operation instructions may comprise a signal to at least one of (i) actuate the at least one drive member, (ii) operate the pump to create a region of negative pressure in the at least one moveable arm, (iii) operate the pump to create a region of positive pressure in the at least one moveable arm.

In some examples, the cartridge may further comprise an alignment feature configured to align the position of the cartridge with the drive member to engage the cartridge with the drive member in the system. For example, the alignment feature may be (i) a moulded element of the common housing; or (ii) a coded tag. This may be advantageous to ensure the cartridge is aligned and/or in the correct orientation for engagement with the drive member when inserted into a sample analysis device. A coded tag may comprise a barcode and/or a RFID chip. Such a barcode and/or RFID chip may be used by the analysis device to indicate the alignment, orientation, and/or contents of the cartridge, for example including the contents of the plurality of containers.

The coded tag may convey data identifying the customised nature of the cartridge to the wireless communication module, including identification of the assays, steps and/or tests contained within. The wireless communication module may then convey specific instructions to the drive member and/or pump. In some examples, the wireless communication module may retrieve the specific instructions from a remote server or device, based on identification data provided by the coded tag. This may be advantageous, for example, if a cartridge comprising materials for a new sample and/or test is launched on the market after the introduction of the system. The coded tag can then be used to advise the system of specific requirements, for example temperature cycling requirements, or time periods, such as settling times during sample aspiration for example. The coded tag may further convey traceability and/or tracking information as well as other useful parameters such as expiry date. The data and instructions encoded on the coded tag may be used automatically by the system, and may be done so selectively either with or without user intervention, to deliver a number of enhanced system benefits, safety, and efficacy warnings, and/or usability features.

### BRIEF DESCRIPTION OF THE DRAWINGS

Embodiments of the disclosure will now be described, by way of example only, with reference to the accompanying drawings, in which:

FIG. 1 shows an example embodiment of a sample preparation cartridge.

FIG. 2 shows a second example embodiment of a sample preparation cartridge.

FIGS. 3A and 3B each show other example embodiments of a sample preparation cartridge.

FIG. 4 shows a fourth example embodiment of a sample preparation cartridge.

FIG. 5A shows another example embodiment of a sample preparation cartridge, comprising a connector module. FIG. 5B shows an example container and connector module, configured for use in the system shown in FIG. 5A.

FIG. 6A shows another example embodiment of a sample preparation cartridge, comprising a connector module. FIG. 6B shows an example container and connector module, configured for use in the system shown in FIG. 6A.

FIG. 7 shows another example embodiment of a sample preparation cartridge.

FIG. 8 shows an example embodiment of a sample preparation cartridge system, comprising a first cartridge and a second cartridge.

FIGS. 9A to 10B show example sample preparation cartridges, each comprising a housings.

FIG. 11 shows another example sample preparation cartridge, comprising a carrousel.

FIGS. 12A and 12B show an example moveable arm and container, suitable for use in any of the sample preparation cartridges of FIGS. 1 to 11.

FIGS. 13A, 13B and 13C show an example sample preparation system comprising a sample preparation device and a sample preparation cartridge, suitable for use with any of the sample preparation cartridges of FIGS. 1 to 11.

### DETAILED DESCRIPTION

Embodiments of the claims relate to a sample preparation cartridge and sample preparation system.

It will be appreciated from the discussion above that the embodiments shown in the Figures are merely exemplary, and include features which may be generalised, removed, or replaced as described herein and as set out in the claims.

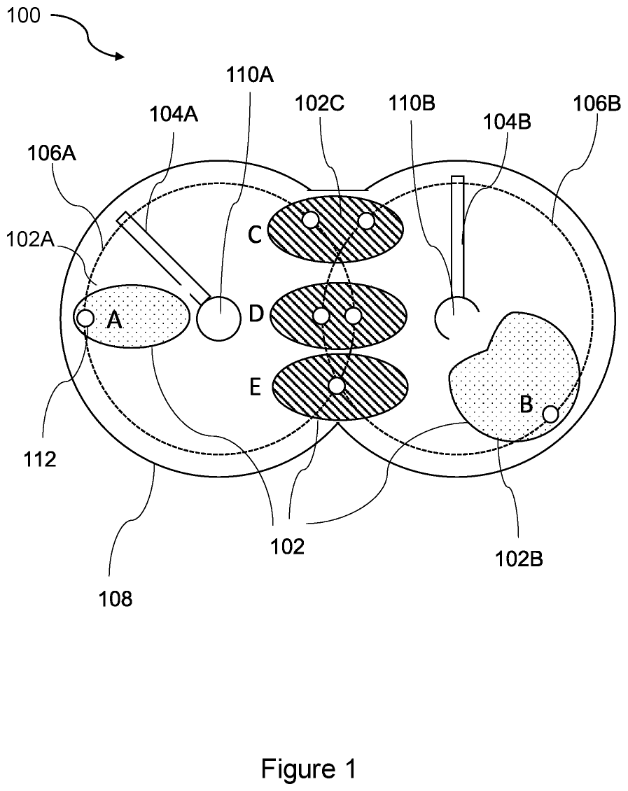

FIG. 1 shows an example sample preparation cartridge 100 for use with a sample preparation device. The cartridge 100 comprises a first moveable arm 104A and a second moveable arm 104B, and a plurality of containers for holding fluid 102, housed within a common housing 108. In this example the housing 108 has the shape of two adjacent and overlapping circles, however the skilled person will understand that any other housing shapes may be used, including but not limited to circular, oval, square, rectangular etc. The first moveable arm 104A is arranged about a first axis 110A of the housing, and the second moveable arm 104B is arranged around a second axis 110B of the housing.

In this example, the first axis 110A and the second axis 110B are arranged off-centre relative to the common housing 108. The spacing between the first axis 110A and the second axis 110B is a function of the length of the first moveable arm 104A and/or the second moveable arm 104B. The spacing between the first axis 110A and the second axis 110B is less than the length of at least one of the of the first moveable arm 104A and/or the second moveable arm 104B such that the rotational trajectory 106A of the first moveable arm 104A about the first axis 110A at least partially overlaps with the rotational trajectory 106B of the second moveable arm 104B about the second axis 110B. In this example, the first moveable arm 104A and the second moveable arm 104B are substantially the same length, however the skilled person will understand that in other examples the first moveable arm 104A and the second moveable arm 104B may be different lengths.

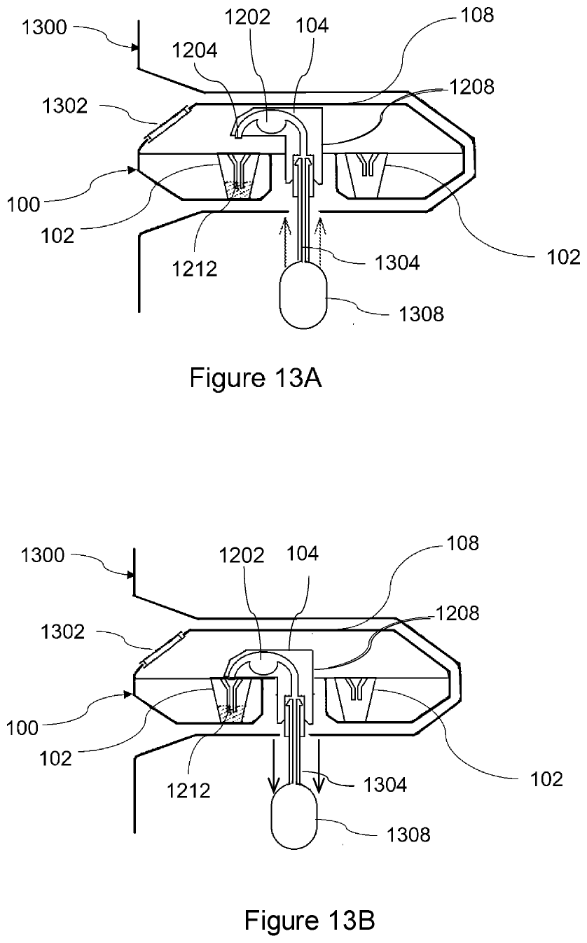

Each moveable arm 104 comprises a cavity configured to support fluid and a receiving portion, coupled to the cavity, configured to receive fluid from a container into the cavity, or dispense fluid from the cavity into a container. An example moveable arm is shown in more detail in FIGS. 12A and 12B.

The plurality of containers 102 are arranged about the housing such that at least a portion of each container lies on the rotational trajectory 106A, 106B of at least one of the first moveable arm 104A or the second moveable arm 104B. In the example shown, containers A, C, D, and E have a substantially oval or elliptical profile, however the skilled person will understand that the containers can have any other shaped profile, as demonstrated by container B, including but not limited to, circular, triangular, square, rectangular, semi-circular, or other polygonal shapes. In other examples, a container may occupy a segment of the cartridge housing 108. Each container 102 comprises an aperture 112. An example container is shown in more detail in FIGS. 12A and 12B.

The plurality of containers 102 comprises a first portion 102A of containers arranged at least partially on the trajectory 106A of the first moveable arm 104A to be only accessible by the first moving arm 104A; and a second portion 102B of containers arranged at least partially on the trajectory 106B of the second moveable arm 104B to be only accessible by the second moving arm 104B. In this example, the first portion 102A and the second portion 102B each comprise only one container, however the skilled person will understand that in other examples, the first portion 102A and/or the second portion 102B may comprise a plurality of containers.

The plurality of containers 102 further comprises a third portion 102C of containers arranged at least partially on the trajectory 106A, 106B of both the first moveable arm 104A and the second moveable arm 104B to be accessible by both the first moving arm 104A and the second moving arm 104B. In this example, the third portion 102C comprises three containers, however the skilled person will understand that the third portion 102C may comprise any number of containers, including only one container.

In the example shown, each container comprises an aperture 112, wherein the aperture is arranged on the rotational trajectory of at least one of the first moveable arm 104A or the second moveable arm 104B.

In the example shown, the sample preparation comprises a first moveable arm 104A and a second moveable arm 104B, however the skilled person will understand that in other examples, the cartridge may comprise at least a third moveable arm, or any other number of moveable arms.

The first moveable arm 104A is configured to rotate around the first axis 110A and the second moveable arm 104B is configured to rotate around the second axis 110B.

Each moveable arm is configured to transfer fluid from one container of the plurality of containers to another container of the plurality of containers. For example, each moveable arm is configured to transfer fluid, analyte, beads, or reagent. The fluid, analyte, beads, or reagent is configured to be drawn into the moveable arm by aspiration, via the aperture 112 of each container 102.

The first moveable arm 104A and the second moveable arm 104B are configured to be rotated and/or operated at least one of (i) independently from one another, (ii) simultaneously, (iii) in parallel, or (iv) in series.

At least one of the plurality of containers 102 may be configured to be removable such that it can be detached from the cartridge 100 (not shown). The removable container may have a variety of different form factors, such as but not limited to a detachable cuvette, vial, syringe, chip, or other container. The removable container comprises a resilient sealing member, for example a rubber seal, configured to seal the removable container when detached from the cartridge to reduce contamination. For example, the removable container may comprise a resilient sealing lid which, upon detachment from the cartridge, is configured to seal the opening through which the fluid was received into the container, for example by the moveable arm. The cartridge 100 may also comprise a separate sealing member which is configured to seal the cartridge 100 when the removable container is detached. For example, the cartridge may comprise a re-sealable opening, or door. This may be advantageous to maintain sterility and avoid contamination of the remaining cartridge.

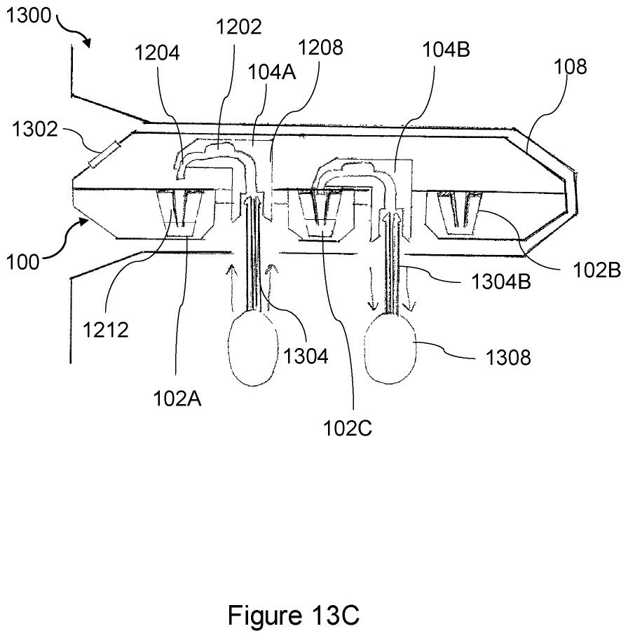

In use, the first moveable arm 104 can be rotated about the first axis 110A to its desired position above a desired container 102 of the first portion of containers 102A within the sample preparation cartridge 100. The first moveable arm 104A can then be lowered, as shown in more detail in FIGS. 12B and 13B. The first moveable arm 104A can then engage with the aperture 112 of a particular container 102 to provide a fluidic seal. The fluid F in the desired container 102 can then be drawn up through the aperture 112 and into the first movable arm 104A by aspiration.

The fluid may be held within a cavity of the first moveable arm 104A whilst the moveable arm 104A is then raised, rotated, and lowered into another desired container 102 where further processing may occur. This may involve dispensing the fluid from the cavity of the first moveable arm 104A into the other container 100. The other desired container may be part of the first portion 102A or third portion 102C of containers. The other desired container may comprise other analytical substances or analytical components in which various substances can be mixed and reactions occur if necessary. This may be repeated as desired.

Meanwhile, the second moveable arm 104B may also be rotated, lowered, aspirated, and raised, repeatedly as desired. The first moveable arm 104A and the second moveable arm 104B may be operated independently and, optionally, simultaneously.

Fluid may be dispensed by the first moveable arm 104A into a container in the third portion of containers 102C and subsequently aspirated by the second moveable arm 104B, or vice versa.

Optionally, fluid may be dispensed by at least one of the first moveable arm or second moveable arm into the removable container. The removable container may then be detached from the cartridge, for example for sample analysis.

Each movable arm 104 can be aligned above a desired container 102 by pre-determined programming of a sample preparation device 1300 and control of a drive member coupled to the moveable arm 104, for example as shown in more detail in FIGS. 13A and 13B. As will be appreciated, there are a number of sample preparation techniques and analytical approaches that the sample preparation cartridge 100 and sample preparation device 1300 according to the invention can be configured to follow, dependent upon the information required in respect of an individual patient.

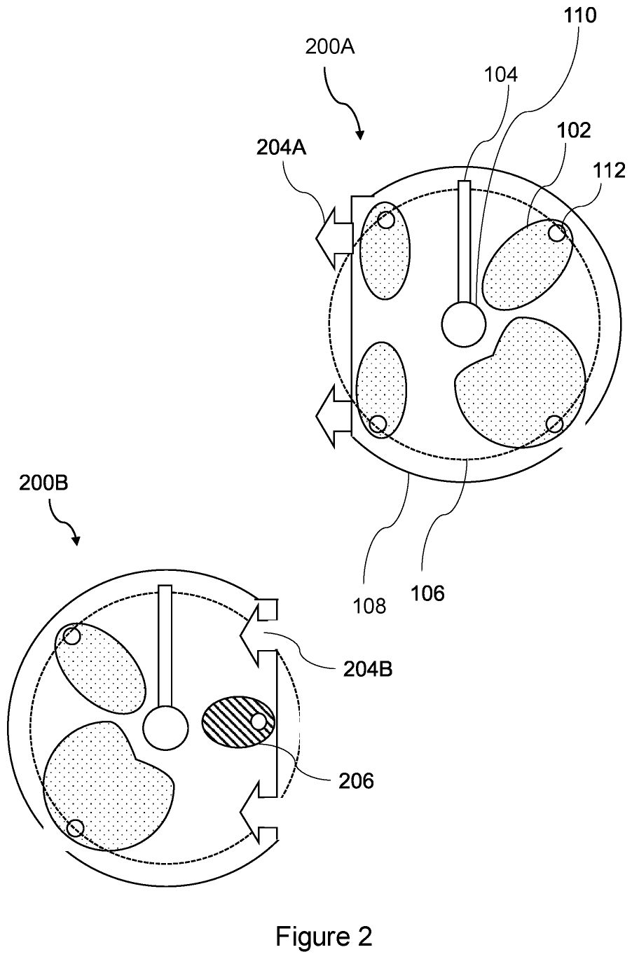

FIG. 2 shows another example sample preparation cartridge 200A for use with a sample preparation device. The cartridge 200A comprises a plurality of containers 102 and a moveable arm 104. In this example, the cartridge 200A comprises a cartridge housing 108 with an irregular shape, being substantially circular with a flat side. As such, at least a portion of the rotational trajectory 106 of the moveable arm 104 extends beyond the cartridge housing 108.

The housing 108 comprises two interlocking structures 204A along the flat side of the housing 108.

The moveable arm 104 is configured to rotate around the axis 110 such that the moveable arm 104 is configured to transfer fluid from a container of the plurality of containers 102 to a container 804 in an adjacent cartridge.

The interlocking structures 204A are configured to couple the cartridge 200 to an adjacent cartridge.

In use, the cartridge 200A may be coupled to another adjacent cartridge, such as cartridge 200B. The cartridge 200A and cartridge 200B may be coupled together by a snap-fit between complementary interlocking structures 204A and 204B. The moveable arm 104 of cartridge 200A is rotates around its axis 110 such that the moveable arm 104 is configured to transfer fluid from a container of the plurality of containers 102 on cartridge 200A to a container, for example container 206 in adjacent cartridge 200B.

The ability to transfer fluid from a container in a first cartridge to a container in an adjacent cartridge may facilitate tailoring the sample preparation workflow in use based on a modular approach. For example, a selection of cartridges may be interchanged, wherein each housing is configured for a different sample preparation workflow, method, or process. Different cartridges may comprise a different plurality of containers, for example comprising at least one different fluid, analyte, beads, or reagent. The interlocking structures 204A and 204B allows the separate cartridges 200A and 200B to be snapped together, to form a set of containers required to prepare the sample, each container being accessible by at least one moveable arm within the dual cartridge. Thus, by coupling a plurality of separate cartridges a tailored workflow may be created.

Purely for illustrative purposes, in one example a first cartridge may be configured to perform sample extraction of DNA from a biological sample, and a second cartridge may be configured to process that sample in a specific way for analysis. For example, the second cartridge may be selected from one cartridge configured for DNA sequencing, or another cartridge configured for end-point PCR. Cartridges may also be selected depending on sample type or volume, for example 10 mL of plasma or 1 mL of bacterial sample.

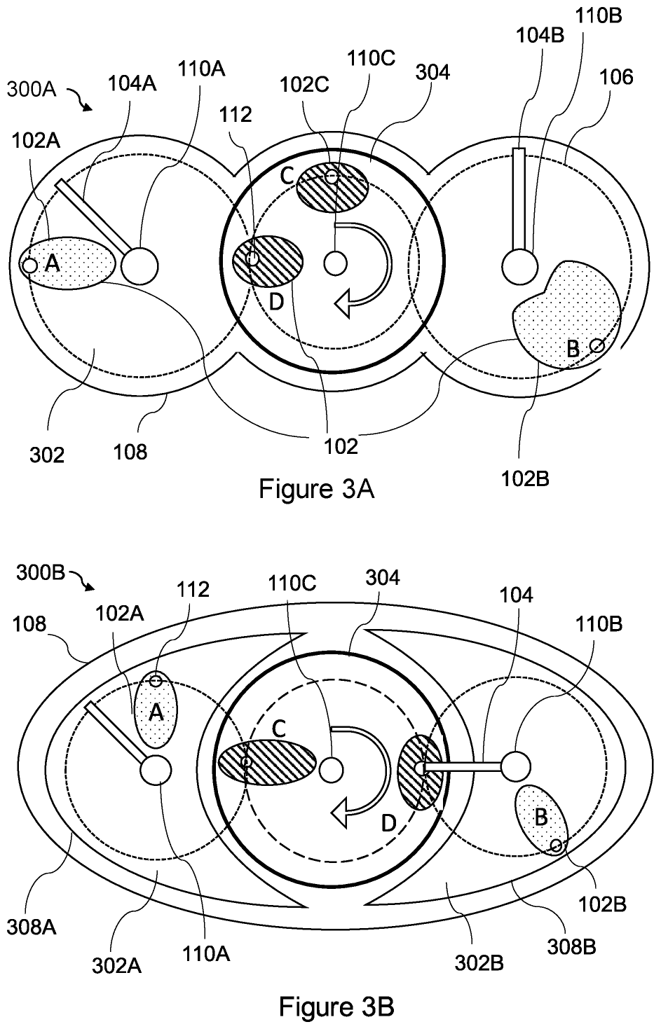

FIG. 3A shows another embodiment of a sample preparation cartridge 300 comprising a first moveable arm 104A, a second moveable arm 104B, and a plurality of containers for holding fluid 102, housed within a common housing 108. The common housing 108 comprises a fixed portion 302 and a carousel portion 304.

The first moveable arm 104A is arranged about a first axis 110A of the housing, and the second moveable arm 104B is arranged around a second axis 1106 of the housing. The first axis 110A and the second axis 110B are arranged off-centre relative to the common housing 108, on the fixed portion 302 of the housing 108. An example moveable arm 104 is shown in FIGS. 12A and 12B.

The carousel portion 304 is arranged about a third axis 110C of the housing. In the example shown in FIG. 3, the first axis 110A, second axis 110B, and third axis 110C are aligned such that the third axis 110C is adjacent to the first axis 110A and the second axis 110B. The carousel portion 304 may be advantageous to increase the number of containers accessible by both the first moveable arm 104A and the second moveable arm 104B for a given cartridge size.

The spacing between (i) the first axis 110A and the third axis 110C, and (ii) the second axis 110B and the third axis 110C, is a function of the length of the first moveable arm 104A and/or the second moveable arm 104B and the radius of the carousel portion 304. The spacing between the first axis 110A/second axis 110B and the third axis 110C is such that the rotational trajectory of each moveable arm at least partially overlaps with the carrousel portion 304. In this example, the first moveable arm 104A and the second moveable arm 104B are substantially the same length, however the skilled person will understand that in other examples the first moveable arm 104A and the second moveable arm 104B may be different lengths.

At least the first axis 110A and the second axis 110B may be arranged off-centre relative to the common housing 108. In this example, the housing 108 has the shape of three linear and overlapping circles, however the skilled person will understand that any other housing shapes may be used, including but not limited to circular, oval, square, rectangular etc. For example, FIG. 3B shows another example cartridge 300B which comprises an ovate or elliptical common housing 108. Within the elliptical common housing 108, the cartridge 300B of FIG. 3B comprises two fixed portions 302A and 302B arranged on opposing sides of the carousel portion 304. In the example shown in FIG. 3B, each fixed portion 302A and 304B comprises a lune or crescent-shaped housing, 308A and 308B respectively. Each lune-shaped housing 308A and 308B is arranged to partially bound a portion of the carrousel portion 304. This may be advantageous to reduce the size of the cartridge 300B by facilitating the carousel portion 304 to be inset or nested relative to fixed portions 304. Each separate housing 308A or 308B may be inserted into the common housing 108 prior to use, for example separate housings 308A and 308B may vary for different samples, preparations, and/or methods etc.

Returning to FIG. 3A, the plurality of containers 102 are arranged about the housing 108 such that at least a portion of each container lies on the rotational trajectory of at least one of the first moveable arm 104A or the second moveable arm 104B, or on the carousel portion 304. The plurality of containers 102 comprises a first portion 102A of containers arranged at least partially on the trajectory of the first moveable arm 104A to be only accessible by the first moving arm 104A; and a second portion 102B of containers arranged at least partially on the trajectory of the second moveable arm 104B to be only accessible by the second moving arm 104B. In the example shown, the first portion 102A and second portion 102B are arranged on the fixed portion 302 of the housing 108. In this example, the first portion 102A and the second portion 102B each comprise only one container, however the skilled person will understand that in other examples, the first portion 102A and/or the second portion 102B may comprise a plurality of containers.

The plurality of containers 102 further comprises a third portion 102C of containers arranged on the carousel portion 304 of the housing 108. The third portion 102C of containers are arranged such that each container is accessible by both the first moving arm 104A and the second moving arm 104B during rotation of the carousel portion 304. In this example, the third portion 102C comprises three containers, however the skilled person will understand that the third portion 102C may comprise any number of containers, including only one container.

The carousel portion 304 is configured to rotate relative to the fixed portion 302. The first moveable arm 104A is configured to rotate around the first axis 110A and the second moveable arm 104B is configured to rotate around the second axis 1106.

The first moveable arm 104A, second moveable arm 104B, and carousel portion 304 are configured to be rotated and/or operated at least one of (i) independently from one another, (ii) simultaneously, (iii) in parallel, or (iv) in series.

Each moveable arm is configured to transfer fluid from one container to another container. For example, each moveable arm is configured to transfer fluid, analyte, beads, or reagent. The fluid, analyte, beads, or reagent is configured to be drawn into the moveable arm by aspiration, via the aperture 112 of a container 102.

In use, the first moveable arm 104 can be rotated about the first axis 110A to its desired position above a desired container 102 of the first portion of containers 102A within the sample preparation cartridge 300A or 300B. The first moveable arm 104A can then be lowered, as shown in more detail in FIGS. 12B and 13B. The first moveable arm 104A can then engage with the aperture 112 of a particular container 102 to provide a fluidic seal. The fluid F in the desired container 102 can then be drawn up through the aperture 112 and into the first movable arm 104A by aspiration.

The fluid may be held within a cavity of the first moveable arm 104A whilst the moveable arm 104A is then raised, rotated, and lowered into another desired container 102 where further processing may occur. This may involve dispensing the fluid from the cavity of the first moveable arm 104A into the other container 102. The other desired container may be part of the first portion 102A or third portion 102C of containers. Where the container is part of the third portion 102C of containers, the carousel portion 304 may be rotated such that the desired container is in reach of the first moveable arm 104A. The other desired container may comprise other analytical substances or analytical components in which various substances can be mixed and reactions occur if necessary. This may be repeated as desired.

Meanwhile, the second moveable arm 104B may also be rotated, lowered, aspirated, and raised, repeatedly as desired. The first moveable arm 104A and the second moveable arm 104B may be operated independently and, optionally, simultaneously.

Fluid may be dispensed by the first moveable arm 104A into a container in the third portion of containers 102C, the carousel portion 304 may then be rotated, and the fluid is subsequently aspirated by the second moveable arm 104B, or vice versa.

Each movable arm 104 can be aligned above a desired container 102 by pre-determined programming of a sample preparation device 1300 and control of a drive member coupled to the moveable arm 104, for example as shown in more detail in FIGS. 13A and 13B, and a drive member coupled to the carousel portion 304 (not shown).

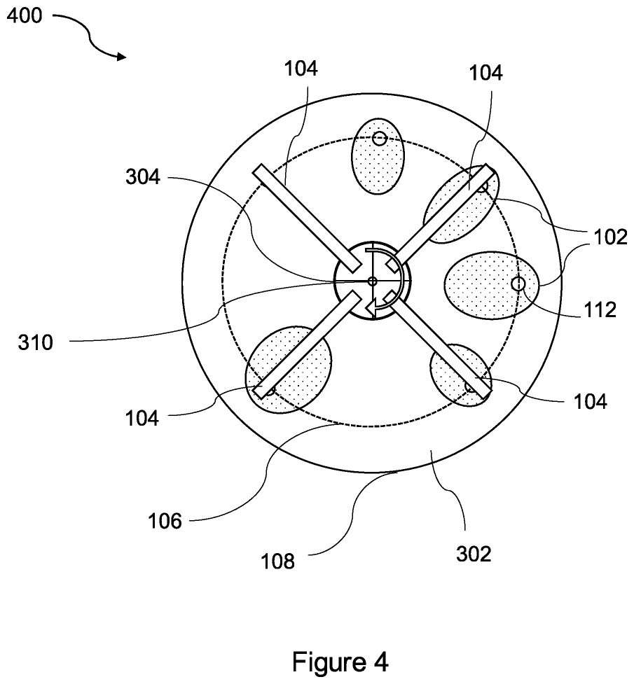

FIG. 4 shows another embodiment of a sample preparation cartridge 400 comprising a first plurality of moveable arms 104, and a plurality of containers for holding fluid 102, housed within a common housing 108. The common housing 108 comprises a fixed portion 302 and a carousel portion 304.

In this example, the plurality of arms 104 are fixed relative to each other and are arranged around a common axis 310. The plurality of moveable arms 104 are coupled to the carousel portion 304 and the common axis 310 is the rotational axis of the carousel portion 304. In the example shown, the plurality of moveable arms 102 comprises four moveable arms arranged to radiate from the common axis 310 at regular intervals. However, the skilled person will understand that in other examples, a different number and configuration of moveable arms may be used. An example moveable arm is shown in more detail in FIG. 12A.

The plurality of containers 102 are arranged at least partially on the rotational trajectory of at least one moveable arm 102. In this example, the plurality of moveable arms 104 are substantially the same length, however the skilled person will understand that in other examples at least one moveable arm may be a different length, comprising a different rotational trajectory.

The plurality of arms 104 are configured to be rotatable relative to the plurality of containers 102. The plurality of moveable arms 104 are configured to rotate around a common axis 310.

Each moveable arm is configured to transfer fluid from one container to another container. For example, each moveable arm is configured to transfer fluid, analyte, beads, or reagent. The fluid, analyte, beads, or reagent is configured to be drawn into the moveable arm by aspiration, via the aperture 112 of a container 102.

Whilst the plurality of moveable arms 104 are configured to be rotated simultaneously, the plurality of moveable arms 104 are configured to be raised, lowered, and/or operated at least one of (i) independently from one another, (ii) simultaneously, (iii) in parallel, or (iv) in series.

In use, the carousel portion 304, including the plurality of moveable arms 104, is rotated about the rotation axis 110 to its desired position within the sample preparation cartridge 400. In some examples, the carousel portion 304 may be lowered such that the plurality of moveable arms 104 are lowered simultaneously. Alternatively, each moveable arm 104 may be lowered (and raised) independently as desired. Similarly, each moveable arm 104 may be aspirated independently as desired.

A receiving portion 1204 of each desired moveable arm 104 can then engage with any engagement portion of a particular container 102 to provide a fluid seal. The fluid F in the desired container 102 can then be drawn up through the first tubular member 1212, via the receiving portion 1204, and into the moving arm cavity 1202.

The fluid may be held within the cavity 1202 whilst the moveable arm 104 is then raised, rotated via the carousel portion 304, and lowered into another desired container 102 where further processing may occur. This may involve dispensing the fluid from the cavity 1202 of the moveable arm 104, into the other container 102. The other desired container may comprise other analytical substances or analytical components in which various substances can be mixed and reactions occur if necessary. The movable arm 104 can be aligned above the desired container 102 by pre-determined programming of the device 1300 and control of the drive member 1304 coupled to the carousel portion.

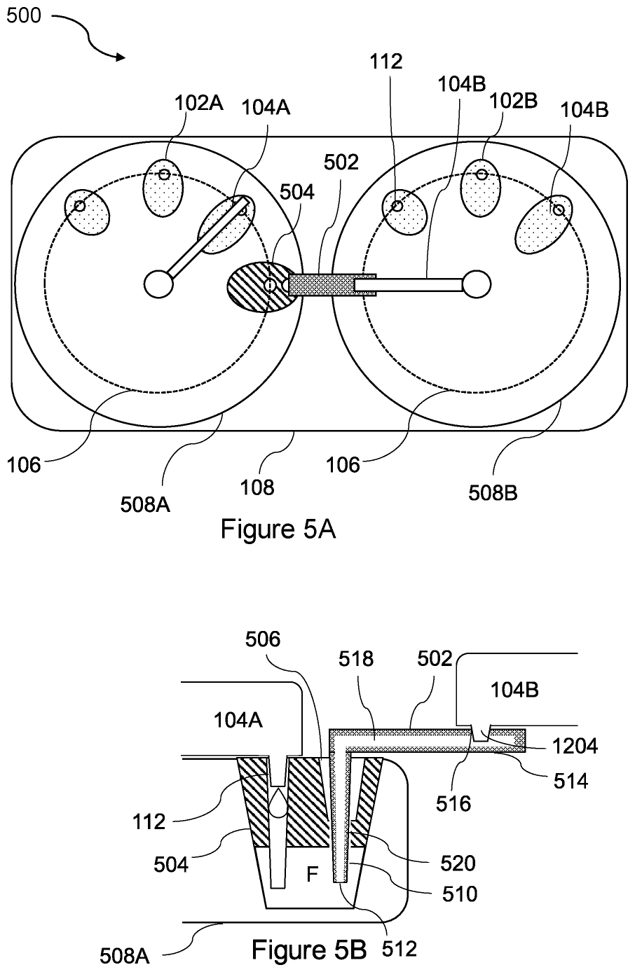

FIG. 5A shows an example sample preparation cartridge 500 for use with a sample preparation device, the cartridge 500 comprising a first housing 508A comprising a first plurality of containers for holding fluid 102A; and a second housing 508B comprising a second plurality of containers 102B for holding fluid. In this example, the first housing 508A and the second housing 508B are both circular. The first housing 508A and the second housing 508B each comprise a moveable arm 104A and 104B, respectively. An example moveable arm 104 is shown in more detail in FIGS. 12A and 12B. The cartridge 500 further comprises a connector module 502 wherein the connector module 502 couples the first housing 508A to the second housing 508B. The first plurality of containers 102 and the second plurality of containers are arranged about their respective housings, 508A and 508B, such that at least a portion of each container 102 lies on the rotational trajectory of the respective moveable arm 104. An example moveable arm 104 and container 102 is shown in more detail in FIGS. 12A and 12B

As shown in more detail in FIG. 5B, the connector module 502 comprises a first end 510 comprising an inlet 512; and a second end 514 comprising an outlet 516. A cavity 518 couples the inlet 512 and the outlet 516. The connector module 502 has a substantially ‘L’ shape, wherein the first end 510 is arranged perpendicular to the second end 514.

The first end 510 of the connector module 502 is coupled to at least one container of the first plurality of containers 102A. In this example, the connector module 502 is coupled to a coupling container 504. As shown in more detail in FIG. 5B, coupling container 504 comprises a cavity for holding fluid F, a first aperture 112 and a second aperture 506.

In this example, the first end 510 is coupled to coupling container 504 through the second aperture 506 by a snap-fit, however the skilled person will understand that other couplings may be used. The first end 510 of the connector module 502 comprises a nozzle 520.

The second aperture 506 (and optionally the first aperture 112) of the container 504 is sealed with a pierceable film or foil. In some examples, the first end of the connector module further comprises a piercing member, configured to pierce the film or foil seal of the container; however, in other examples the nozzle 520 may be configured to pierce the film or foil seal.

Each moveable arm is configured to transfer fluid from at least one container of the first or second plurality of containers to at least another container of the same plurality of containers. For example, each moveable arm is configured to transfer fluid, analyte, beads, or reagent. The fluid, analyte, beads, or reagent is configured to be drawn into the moveable arm by aspiration, via the aperture 112 of a container 102.

The inlet 512 is configured to receive fluid F from container 504. The nozzle 520 is configured to extend into the container 504 to reach the fluid F.

The cavity 518 configured to permit the flow of fluid F from the inlet 512 to the outlet 516. The outlet 516 is configured to dispense fluid F. Fluid is configured to be drawn into the inlet 512 and out of the outlet 516 by aspiration.

In the example shown in FIGS. 5A and 5B, the outlet 516 of the connector module 502 is configured to reversibly engage with the second moveable arm 104B. The second moveable arm 104B is configured to be moved between (i) an engaged configuration, wherein the moveable arm 104B is in sealed engagement with the outlet 516 of the connector module 502; and (ii) a displaced configuration, wherein the moveable arm 104B is displaced from the connector module 502. In the engaged configuration, the receiving portion 1204 of the moveable arm forms a fluidic seal with the outlet 516 of the connector module 502.

In some examples, the connector module 502 further comprises a one-way valve (not shown) arranged in the cavity 518 configured to prevent the flow of fluid from the outlet 516 to the inlet 512.

In use, the first moveable arm 104A is rotated to its desired position above a desired container of the first plurality of containers 102A within the sample preparation cartridge 500. The first moveable arm 104A can then be lowered, as shown in more detail in FIG. 12B. The first moveable arm 104A can then engage with any engagement portion of a particular container 102 to provide a fluid seal. The fluid F in the desired container 102 can then be drawn up into the first moving arm 104A. The fluid may be held within the cavity 1202 whilst the first moveable arm 104A is then raised, rotated, and lowered into another desired container 102 where further processing may occur. This may be repeated any number of times for different containers within the first plurality of containers 102A. The first moveable arm 104 is then raised, rotated, and lowered into the coupling container 504. The first moveable arm dispenses the fluid from the moveable arm 104A, via the first aperture 112, into the coupling container 504.

Meanwhile, the second moveable arm 104B is rotated and lowered to engage with the outlet 516 of the connector module 502. The fluid F in the coupling container 504 can then be drawn by aspiration into the connector module 502 via the inlet, and into the second moveable arm 104B via the outlet 516. The fluid may be held within a cavity of the second movable arm 104B whilst the second moveable arm 104B is then raised, rotated, and lowered into another desired container 102 where further processing may occur.

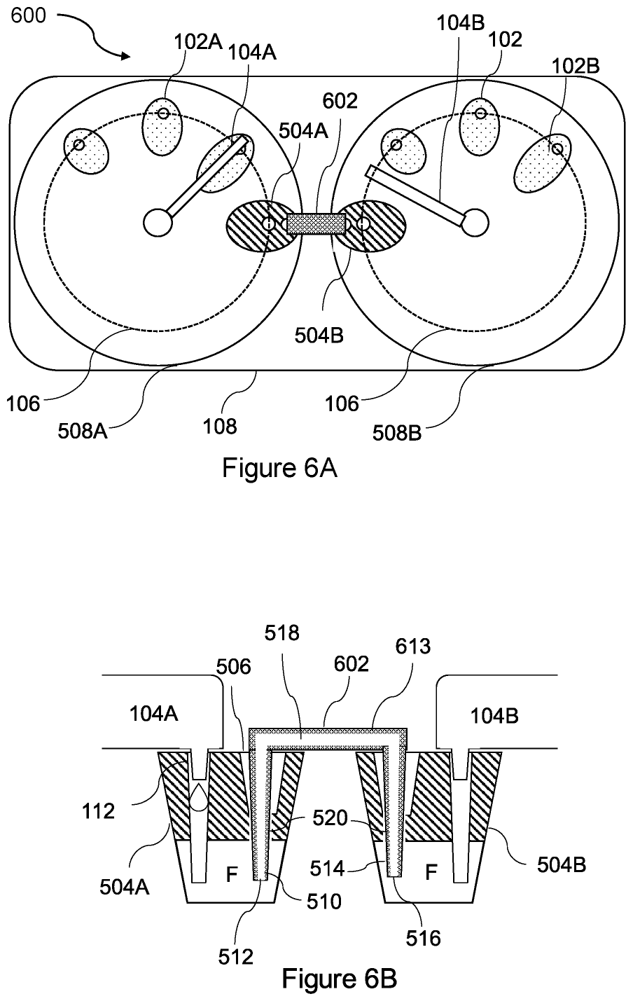

FIGS. 6A and 6B show an alternative sample preparation cartridge 600 comprising a first housing 508A comprising a first plurality of containers for holding fluid 102A; a second housing 508B comprising a second plurality of containers 102B for holding fluid; and a connector module 502 wherein the connector module 602 couples the first housing 508A to the second housing 508B. The first housing 508A and the second housing 508B each comprises at least one moveable arm 104A and 104B, respectively.

As shown in more detail in FIG. 6B, the connector module 602 comprises a first end 510 comprising an inlet 512; and a second end 514 comprising an outlet 516. A cavity 518 couples the inlet 512 and the outlet 516. The connector module 602 has a substantially ‘U’ shape, wherein the first end 510 is arranged parallel to the second end 514, and wherein the first end 510 and the second end 514 are coupled by a perpendicular mid portion 613.

The first end 510 of the connector module 602 is coupled to at least one container of the first plurality of containers 102A. In this example, the first end 510 is coupled to container 504A. The second end 514 of the connector module 602 is coupled to at least one container of the second plurality of containers 102B. In this example, the second end 514 is coupled to container 504B.

As shown in more detail in FIG. 6B, containers 504A and 504B each comprises a cavity for holding fluid F, a first aperture 112 and a second aperture 506. The first end 510 and second end 514 are coupled to containers 504A and 504B through the second aperture 506 by a snap-fit, however the skilled person will understand that other couplings may be used. The first end 510 and second end 514 of the connector module 602 each comprise a nozzle 520.

Optionally, at least the second aperture 506 at least one of container 504A or 504B is sealed with a pierceable film or foil. In some examples, the first end 510 and/or second end 514 of the connector module 602 further comprises a piercing member, configured to pierce the film or foil seal of the container; however, in other examples the nozzle 520 may be configured to pierce the film or foil seal.

Each moveable arm is configured to transfer fluid from at least one container of the first or second plurality of containers to at least another container of the same plurality of containers. For example, each moveable arm is configured to transfer fluid, analyte, beads, or reagent. The fluid, analyte, beads, or reagent is configured to be drawn into the moveable arm by aspiration, via the aperture 112 of a container 102. The connector module 602 is configured to transfer fluid from at least one container of the first plurality of containers to at least one container of the second plurality of containers.

In some examples, the connector module 602 further comprises a one-way valve (not shown) arranged in the cavity 518 configured to prevent the flow of fluid from the outlet 516 to the inlet 512.

In use, the first moveable arm 104A is rotated to its desired position above a desired container of the first plurality of containers 102A within the sample preparation cartridge 600. The first moveable arm 104A can then be lowered, as shown in more detail in FIG. 12B. The first moveable arm 104A can then engage with an engagement portion of a particular container 102 to provide a fluid seal. The fluid F in the desired container 102 can then be drawn up into the first moving arm 104A. The fluid may be held within the cavity 1202 whilst the first moveable arm 104A is then raised, rotated, and lowered into another desired container 102A of the first plurality of containers where further processing may occur. This may be repeated any number of times for different containers within the first plurality of containers 102A. The first moveable arm 104 is then raised, rotated, and lowered into the first coupling container 504A. The first moveable arm dispenses the fluid from the moveable arm 104A, via the first aperture 112, into the coupling container 504.

Meanwhile, the second moveable arm 104B is rotated and lowered to engage with aperture 112 of the second coupling container 504B. The fluid F in the first coupling container 504A can then be drawn by aspiration into the connector module 602 via the inlet, into the second coupling container 504B via the outlet 516, and into the second moveable arm 104B through the aperture 112 of the second coupling container 504B. The fluid may be held within a cavity of the second movable arm 104B whilst the second moveable arm 104B is then raised, rotated, and lowered into another desired container 102 where further processing may occur.

In the example shown in FIG. 6B, the connector module 602 is coupled between the first coupling container 504A and the second coupling container 504B in a “bridge” configuration, such that the mid portion 613 of the connector module 602 is arranged above the coupling containers 504A and 504B, in particular above the fluid F held by the containers. However, the skilled person will understand that in other examples, the connector module 602 may be coupled between the first coupling container 504A and the second coupling container 504B in a “tunnel” configuration, such that the mid portion 613 of the connector module 602 is arranged below the coupling containers 504A and 504B, in particular below the fluid F held by the containers. In this case, the second aperture 506 of each coupling container 504 may be arranged on the underside of each container (opposite to the surface shown in FIG. 6B), below the fluid F. Each nozzle 520 of the connector module 602 may be configured to couple to the second aperture 506 by a snap-fit, preferably wherein the engagement between the connector module 602 and the second aperture 506 is fluid sealing; however, the skilled person will understand that other couplings may be used.

In the examples shown in FIGS. 5A to 6B, the connector module 602 may optionally comprise a matrix in the cavity 518 that performs a specific function beyond fluid transfer between housings. For example, in some examples, the cavity 518 may comprise a desalting matrix configured to desalt the fluid, F, as it is transferred from the inlet 512 to the outlet 516.

In the examples shown in FIGS. 5A to 6B, the first housing 508A, the second housing 508B, and the connector module 402 are arranged in a common housing 108. However, the skilled person will understand that in other examples, the first housing is a first separate sample preparation cartridge, and the second housing is a second separate sample preparation cartridge, wherein the connector module 502 couples the first cartridge to the second cartridge.

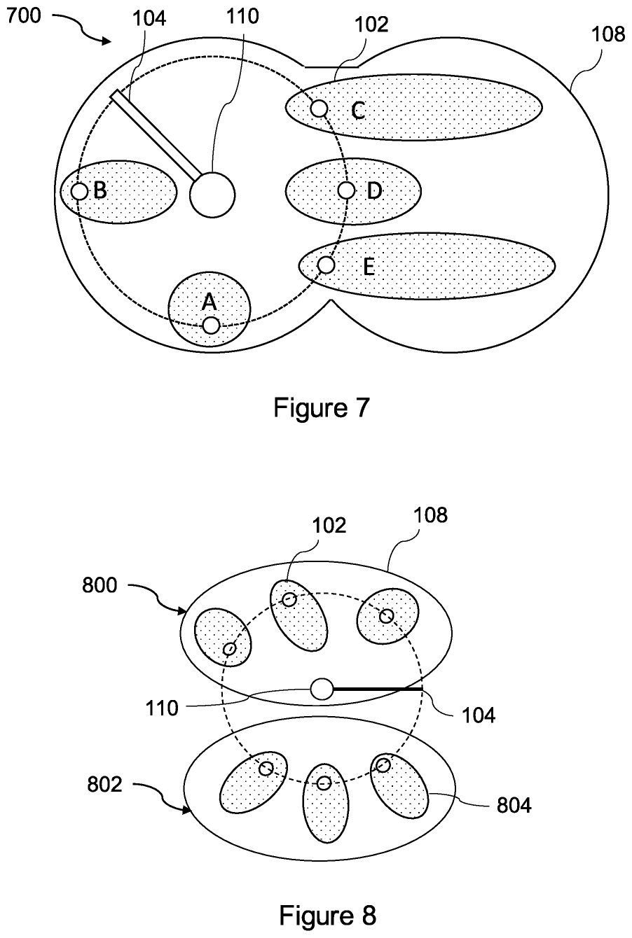

FIG. 7 shows another example sample preparation cartridge 700 for use with a sample preparation device, the cartridge 700 comprising a plurality of containers 102 and a moveable arm 104 arranged in a housing 108. In the example shown in FIG. 7, the housing 108 has the shape of two adjacent and overlapping circles, however the skilled person will understand that any other housing shapes may be used, including but not limited to circular, oval, square, rectangular etc. The moveable arm 104 is arranged to rotate around an off-centre axis 110 of the housing 108, and optionally the cartridge 700.

At least a portion of each container of the plurality of containers 102 are arranged around the off-centre axis 110 such that at least a portion of each container lies on the rotational trajectory of the moveable arm 104A

In the example shown, at least a portion of the plurality of containers are configured to hold different volumes and/or have a different profile.

In the example shown in FIG. 7, the cartridge has one moveable arm 104, however the skilled person will understand that in other examples, the cartridge may comprise a plurality of moveable arms.

The plurality of containers 102 are configured to be accessible by the moveable arm 104 such that the moveable arm 104 configured to transfer fluid from one container of the plurality of containers 102 to another container of the plurality of containers 102.

The sample preparation cartridge 700 is inserted into a sample preparation device 1300, for example as shown in FIG. 13A. A drive member 1304 of the device 1300 is raised to engage with the shaft 1208 of the sample preparation cartridge 700. The moveable arm 104 can then be rotated about the shaft 1208 to its desired position above a desired container 102 within the sample preparation cartridge 700. The moveable arm 104 can then be lowered, as shown in FIG. 13B. The receiving portion 1204 of the moveable arm 104 can then engage with any engagement portion of a particular container 102 to provide a fluid seal. The fluid F in the desired container 102 can then be drawn up through the aperture 112 and into the moving arm 104 by aspiration.

The fluid may be held within the movable arm 104 whilst the moveable arm 104 is then raised, rotated, and lowered into another desired container 102 where further processing may occur. This may involve dispensing the fluid from the moveable arm 104, into the other container 102. The other desired container may comprise other analytical substances or analytical components in which various substances can be mixed and reactions occur if necessary. The movable arm 104 can be aligned above the desired container 102 by pre-determined programming of the device 1300 and control of the drive member 1304.

As will be appreciated, there are a number of sample preparation techniques and analytical approaches that the sample preparation cartridge 700 and sample preparation device 1300 according to the invention can be configured to follow, dependent upon the information required in respect of an individual patient.

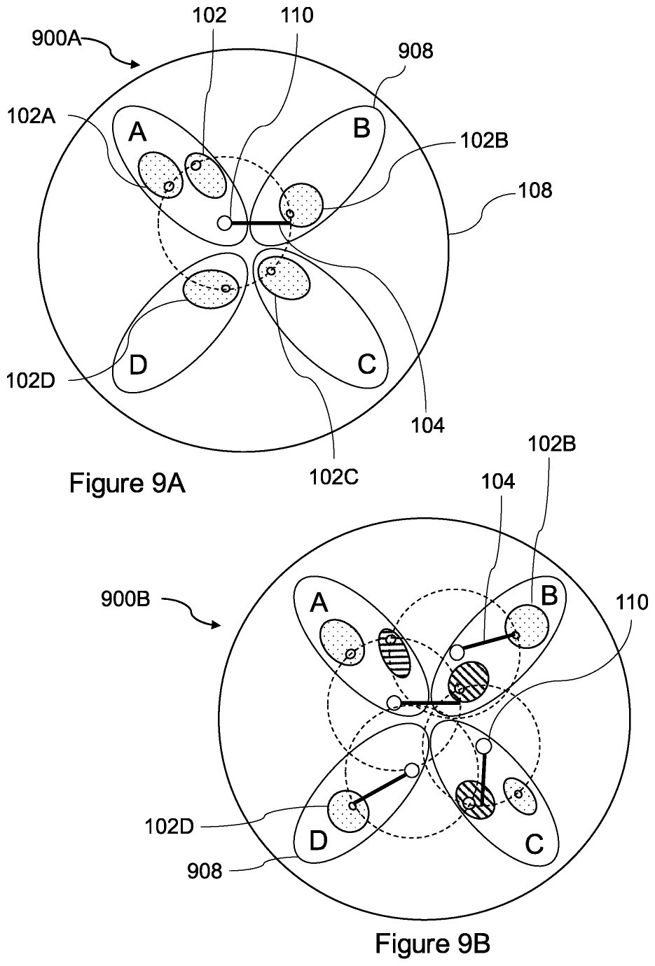

FIG. 8 shows another example sample preparation cartridge 800 for use with a sample preparation device. The cartridge 800 comprises a plurality of containers 102 and a moveable arm 104, wherein the moveable arm 104 is arranged to rotate around an off-centre axis 110 of the cartridge 800. In this example, the cartridge 800 has a substantially ovate or elliptical housing 108. The off-centre axis 110 is arranged at an off-centre position along the minor axis of the housing 108. However, the skilled person will understand that this is merely an example, and cartridges of other shapes may be used provided the rotational trajectory of the moveable arm 104 extends beyond the cartridge housing 108.

The moveable arm 104 is configured to rotate around the off-centre axis 110 such that the moveable arm 104 is configured to transfer fluid from a container of the plurality of containers 102 to a container 804 in an adjacent cartridge 802.

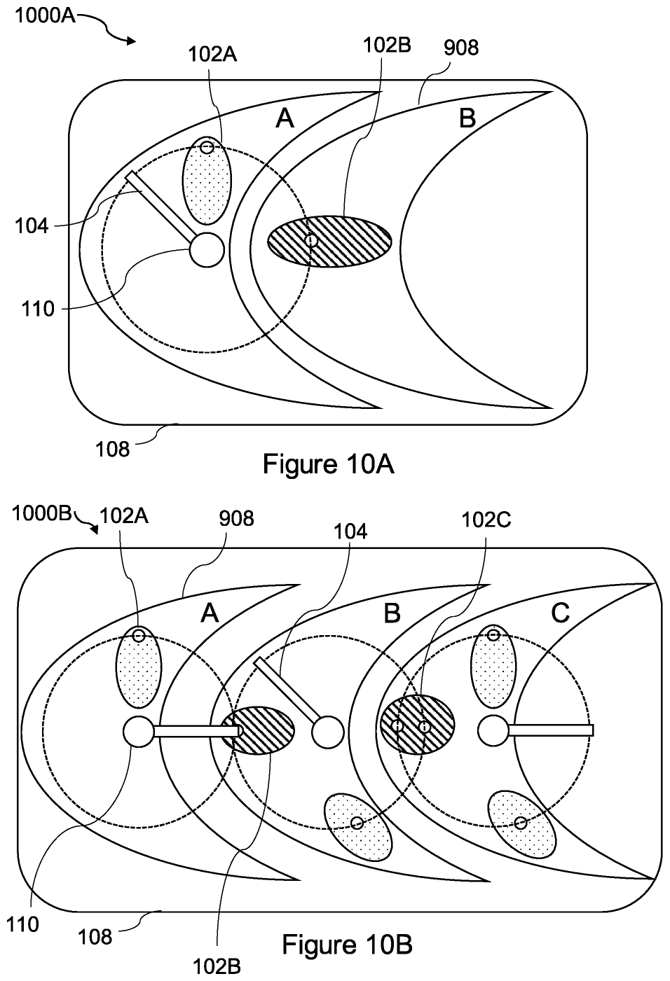

FIG. 9A shows another example sample preparation cartridge 900A for use with a sample preparation device. The cartridge 900A comprises a plurality of separate housings 908, in this example the cartridge 900A comprises four housings 980A-D. Each housing 908 comprises at least one container 102, such that the cartridge 900A comprises a plurality of containers 102. A first portion 102A of the plurality of containers 102 is arranged on first housing 908A; a second portion 102B of the plurality of containers 102 is arranged on second housing 908B; a third portion 102C of the plurality of containers 102 is arranged on third housing 908C; and a fourth portion 102D of the plurality of containers 102 is arranged on fourth housing 908D. In the example shown, the second, third, and fourth portions of containers 102B, 102C, and 102D comprise one container each; however the skilled person will understand that this is merely an example, and that in other examples any of the second, third, and fourth portions of containers 102B, 102C, and 102D may comprise a plurality of containers 102.

The cartridge 900A also comprises a common cartridge housing 108 comprising four receiving portions. In this example, the common cartridge housing 108 has a substantially circular shape and is arranged to encompass the plurality of housings 908A-908D.

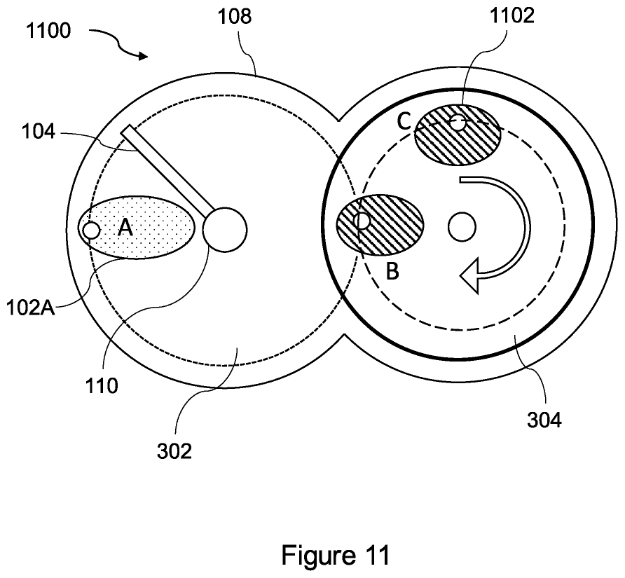

In this example, each separate housing 908A-D has a substantially ovoid or elliptic shape. The major axis of each elliptical housing 908A-D is arranged to radiate from a central point. However, the skilled person will understand that this is merely an example and housings of other shapes may be used. For example, another example embodiment is shown in FIG. 10A, wherein each housing has a substantially lune or crescent shape. In FIG. 10A, the first housing is arranged to partially bound a portion of the second housing. This may be advantageous to reduce the size of the cartridge, including the common cartridge housing 108, by facilitating the second housing to be inset or nested relative to first housing.

In the example shown in FIG. 9A, the first housing 908A comprises a moveable arm 104. The moveable arm 104 is arranged to rotate around an off-centre axis 110 of the housing 908A and, optionally, wherein the off-centre axis 110 is also arranged off-centre relative to the common cartridge housing 108. The off-centre axis 110 is arranged at an off-centre position along the major axis of the elliptical housing 908A.

The moveable arm 104 is configured to transfer fluid from a container of the first plurality 102A of containers to at least one of a container of (i) the second plurality of containers 102B, (ii) the third plurality of containers 102C, and (iii) the fourth plurality of containers 102D.

Each receiving portion in the common cartridge housing 108 is configured to receive a housing 908. The separation between the receiving portions of the common cartridge housing 108 is a function of the length of the moveable arm 104 such that the moveable arm 104 may be arranged to transfer fluid from a container of the first housing 908A to a container of at least one of (i) the second housing 908B, (ii) the third housing 908C, and (iii) the fourth housing 908D.

FIG. 9B shows an alternative embodiment to that shown in FIG. 9A, wherein each of the separate housings 908A-D comprises a moveable arm 104. Each moveable arm 104 is arranged to rotate around an off-centre axis 110 of its respective housing 908A-D and, optionally, wherein each off-centre axis 110 is also arranged off-centre relative to the cartridge 900B.

In the example shown, at least a subset of the first portion of containers 102A, the second portion of containers 102B, and the third portion of containers 102C are arranged to be accessible by at least two moveable arms 104. However, in this example the fourth portion of containers 102D is only accessible by the moveable arm 104 of the fourth housing 908D.

In this example, similarly to FIG. 9A, each separate housing 908A-D has a substantially ovoid or elliptic shape. The major axis of each elliptical housing 908A-D is arranged to radiate from a central point. However, the skilled person will understand that this is merely an example and housings of other shapes may be used. For example, another example embodiment is shown in FIG. 10B, wherein each housing 908 has a substantially lune or crescent shape. In FIG. 10B, the first housing 908A is arranged to partially bound a portion of the second housing 908B, and likewise the second housing 908B is arranged to partially bound a portion of the third housing 908C. This may be advantageous to reduce the size of the cartridge, including the common cartridge housing 108, by facilitating the plurality of housings to be inset or nested relative to one another.

Each moveable arm 104 is arranged to transfer fluid from a container of one plurality of containers 102 to a container of another plurality of containers.

In use, the sample preparation cartridge 900 is inserted into a sample preparation device 1300, for example as shown in FIG. 13A. A plurality of drive members 1304 of the device 1300 are raised to each engage with a shaft 1208 of a moveable arm 104 of the sample preparation cartridge 900. Each drive member may independently raise, lower, and rotate a moveable arm 104. The plurality of drive members are preferably controlled by a single controller, this may be advantageous to avoid collisions between moveable arms in operation.

The ability to transfer fluid from a container of the first plurality of containers 102A to a container in an adjacent housing as shown in FIGS. 9A to 10B, including any container of the second 102B, third 102C and fourth 102D plurality of containers, may facilitate tailoring the sample preparation workflow in use based on a modular approach. For example, a selection of housings, in this example 908A, 908B, (and optionally 908C and 908D), may be interchanged, wherein each housing is configured for a different sample preparation workflow, method, or process. Different housings may comprise a different plurality of containers, for example comprising at least one different fluid, analyte, beads, or reagent. The common cartridge housing 108 allows the plurality of separate housings 908 to be snapped into a receiving portion, to form part of the set, accessible by at least one moveable arm within the cartridge, required to prepare the sample. Thus, by selecting a plurality of housings a tailored workflow may be created.

Purely for illustrative purposes, in one example a first housing 908A may be configured to perform sample extraction of DNA from a biological sample, and a second housing 908B may be configured to process that sample in a specific way for analysis. For example, the second housing 908B may be selected from one housing configured for DNA sequencing, or another housing configured for end-point PCR. Housings 908 may also be selected depending on sample type or volume, for example 10 mL of plasma or 1 mL of bacterial sample.

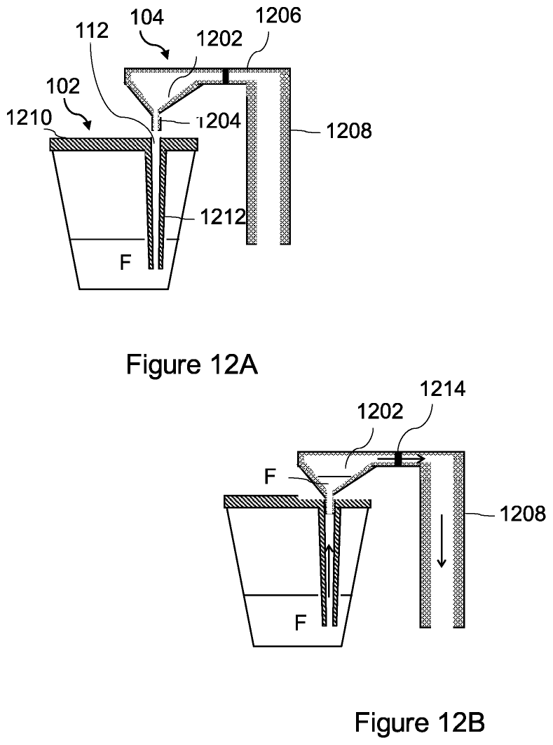

FIG. 11 shows another example sample preparation cartridge for use with a sample preparation device, the cartridge comprising a fixed portion 302 and a carousel portion 304, wherein the carousel portion 304 is configured to rotate relative to the fixed portion 302. The fixed portion 302 comprises a first plurality of containers 102A, and the carousel portion 304 comprises a second plurality of containers 1102.

The fixed portion 302 further comprises a moveable arm 104, wherein the moveable arm 104 is configured to transfer fluid from one container of the first 102A or second 1102 plurality of containers to another container of the first 102A or second 1102 plurality of containers.

In this example, the cartridge 1100 comprises only one moveable arm 104, however the skilled person will understand that in other examples, the cartridge may comprise a plurality of moveable arms, for example wherein at least a portion of the plurality of moveable arms are arranged about the same rotational axis 110, and/or wherein at least a portion of the plurality of moveable arms are arranged around at least one different rotational axis, for example but not limited to as shown in FIGS. 3A and 3B.

The moveable arm 104 is configured to transfer fluid (i) from a container of the carousel portion 304 to a container of the fixed portion 302; (ii) from a container of the fixed portion 302 to a container of the carousel portion 304; (iii) from one container of carousel portion 304 to another container of carousel portion 304; and (iv) from one container of fixed portion 302 to another container of fixed portion 302.

In use, the sample preparation cartridge 1100 is inserted into a sample preparation device 1300, for example as shown in FIG. 13A. A first drive members 1304 of the device 1300 is raised to engage with the shaft 1208 of the moveable arm 104 of the sample preparation cartridge 1100. The first drive member may raise, lower, and rotate a moveable arm 104. A second drive member of the device 1300 (not shown) is raised to engage with carousel portion 304. The second drive member may rotate the carousel portion 304. The plurality of drive members are preferably controlled by a single controller, this may be advantageous to control rotation of the movable arm and carousel portion such that the moveable arm can be positioned above a desired container on the carousel portion 304.

FIGS. 12A and 12B show an example moveable arm 104 and container 102, suitable for use in any of the sample preparation cartridges disclosed herein. In the example shown, the container 102 comprises an engagement portion 1210 comprising an aperture 112. The engagement portion 1210 further comprises a first tubular member 1212 which extends from the aperture 112 into the at least one container 102. In this example, the first tubular member 1212 has a conical shape with a high aspect ratio, however the skilled person will understand that other tubular shapes may be used.

The moveable arm 104 comprise a cavity 1202 and a receiving portion 1204, coupled to the cavity 1202. The cavity 1202 is coupled to the distal end of an elongate arm member 1206. The proximal end of the elongate arm member 1206 is coupled to a shaft 1208. In the example shown, the cavity has a conical shape. and the receiving portion 1204 of the moveable arm 104 comprises a second tubular member arranged at the lowest point of the cavity 1202. However, the skilled person will understand this is merely one example. An alternative moveable arm 104 is shown in FIGS. 13A to 13C wherein the receiving portion 1204 comprises a tubular member 1204 and the cavity 1202 comprises a bulb arranged along the tubular member 1204. In the example shown in FIGS. 13A to 13B, at least a portion of the bulb is arranged below the tubular member. In the example shown in FIGS. 13C, at least a portion of the bulb is arranged above the tubular member.

Returning to FIGS. 12A and 12B, the cavity 1202 of the moveable arm 104 is configured to support fluid. The receiving portion 1204 is configured to receive fluid from a container 102 into the cavity 1202 or dispense fluid from the cavity 1202 into a container 102.

The engagement portion 1210 of the container 102 is configured to reversibly engage with the receiving portion 1204 of a movable arm 104.

The moveable arm 104 is configured to be moved between (i) an engaged configuration, wherein the receiving portion 1204 of the moveable arm 104 is in sealed engagement with the engagement portion 1210 of the container 102 (as shown in FIG. 12B); and (ii) a displaced configuration, wherein the moveable arm 104 is vertically displaced from the container 102 (as shown in FIG. 12A). In the engaged configuration, the receiving portion 1204 of the moveable arm 104 may form a fluidic seal with the engagement portion 1210 of the container 102.

Fluid is configured to be drawn from the container 102 through the first tubular member 1212 and into the cavity 1202 of the moveable arm 104 by aspiration.

In some examples, at least one of (i) the second tubular member and (ii) the cavity may be detachable from each moveable arm such that the at least one of (i) the second tubular member and (ii) the cavity may be replaceable. This may be advantageous to remove used and contaminated sections of the moveable arm to reduce contamination of fluid.

In use, a drive member engages with the shaft 1208. The drive member actuates the moveable arm 104 by moving the shaft 1208, for example as shown in more detail in FIGS. 13A and 13B. The drive member may move the shaft 1208 in the axial direction, thereby raising and lowering the receiving portion 1204 with respect to the individual containers 102. The drive member can also rotate the shaft 1208 to move the receiving portion 1204 so it is positioned above a container 102.

In the lowered or “engaged” configuration, as shown in FIG. 12B, the receiving portion engages and fluidly seals with the fixed first tubular member of the container. Fluid is then drawn from the container 102 through the first tubular member 1212 and into the cavity 1202 of the moveable arm 104 by aspiration. Alternatively, fluid may be dispensed from the cavity 1202 into a container 102.

Mixing of fluids within a container 102 can be achieved by repeatedly aspirating and dispensing fluid into the receiving portion 1204 so as to cause rapid fluid movement within the container 102. This yields fast and comprehensive mixing without requiring additional systems to vibrate or agitate the cartridge.

FIGS. 13A and 13B illustrate an example cartridge in use within a sample preparation device 1300.

The sample preparation device 1300 comprises plurality of drive members 1304 (only one shown) and at least one pump 1308.

In use, a sample is placed within at least one container 102 in the sample preparation cartridge 100, for example via a sealable inlet 1302 in the housing 108. The sample preparation cartridge 100 is then inserted into a sample preparation device 1300, as shown in FIG. 13A.

A first drive member 1304 of the device 1300 is raised to engage with the shaft 1208 of the first moveable arm 104A of the sample preparation cartridge 100. The first moveable arm 104A can then be rotated about the shaft 1208 to its desired position above a desired container 102 within the sample preparation cartridge 100. The moveable arm 104 can then be lowered, as shown in FIG. 13B. The receiving portion 1204 of the moveable arm 104 can then engage with any engagement portion of a particular container 102 to provide a fluid seal. The fluid F in the desired container 102 can then be drawn up through the first tubular member 1212, via the receiving portion 1204, and into the moving arm cavity 1202. The fluid F is drawn up by aspiration as a result of operation of the pump. The internal volume of the cavity 1202 in the moveable arm 104 ensures that fluid can be transferred by the movable arm 104 without the need for liquid to flow through the elongate arm member 1206 or the shaft 1208, into the pump 1308. A filter or valve 1214 between the cavity 1202 and pump 1308 is configured to prevent airborne particles contaminating the pump system.

The fluid may be held within the cavity 1202 whilst the moveable arm 104 is then raised, rotated, and lowered into another desired container 102 where further processing may occur. This may involve dispensing the fluid from the cavity 1202 of the moveable arm 104, into the other container 100. The other desired container may comprise other analytical substances or analytical components in which various substances can be mixed and reactions occur if necessary. The movable arm 104 can be aligned above the desired container 102 by pre-determined programming of the device 1300 and control of the drive member 1304.

Meanwhile, a second drive member 1304B, for example as shown in FIG. 13C, of the device 1300 may be raised to engage with the shaft 1208 of the second moveable arm 104B of the sample preparation cartridge 100. The second moveable arm 104B can then also be rotated, lowered, aspirated, and raised, repeatedly as desired. As the second drive member is independent to the first drive member, the first moveable arm and the second moveable arm may be operated independently.

Fluid may be dispensed by the first moveable arm 104A into container 102C, wherein container 102C is accessible by both the first moveable arm 104A and the second moveable arm 104B, and subsequently aspirated by the second moveable arm 104B, or vice versa.

Optionally, fluid may be dispensed by at least one of the first moveable arm or second moveable arm into a removable container. The removable container may then be detached from the cartridge 100, for example for sample analysis.

As will be appreciated, there are a number of sample preparation techniques and analytical approaches that the sample preparation cartridge 100 and sample preparation device 1300 according to the invention can be configured to follow, dependent upon the information required in respect of an individual patient.

For illustrative purposes, cartridge 100 of FIG. 1 is shown in FIGS. 13A and 13B, however the skilled person will understand that the system may be used with any sample preparation cartridge disclosed herein. The number of drive members of the device 1300 may be adjusted depending on the number of rotational axes, the number of moveable arms, and/or the presence of a carousel portion, accordingly. In some examples, the device 1300 may receive at least two cartridges, for example but not limited to cartridges 200A and 200B, or 800 and 802. At least one drive member may engage with each cartridge which can then be operated at least one of (i) independently, (ii) simultaneously, (iii) in parallel, or (iv) in series with any other cartridge within the device 1300.

In the context of the present disclosure other examples and variations of the apparatus and methods described herein will be apparent to a person of skill in the art.

1. A sample preparation cartridge for use with a sample preparation device, the cartridge comprising:
a plurality of containers for holding fluid;
a first moveable arm; and
a second moveable arm;
wherein each moveable arm is configured to transfer fluid from one container of the plurality of containers to another container of the plurality of containers.

2. The sample preparation cartridge of claim 1 wherein the plurality of containers comprises:
a first portion of containers arranged to be only accessible by the first moving arm; and
a second portion of containers arranged to be only accessible by the second moving arm.

3. The sample preparation cartridge of claim 2 wherein the plurality of containers comprises a third portion of containers arranged to be accessible by both the first moving arm and the second moving arm.

4. The sample preparation cartridge of claim 1 wherein the plurality of containers are arranged in a common housing.

5-6. (canceled)

7. The sample preparation cartridge of claim 1 wherein:
the first moveable arm is configured to rotate around a first axis;
the second moveable arm is configured to rotate around a second axis.

8. The sample preparation cartridge of claim 7, wherein at least one of the first axis or second axis is arranged off-centre relative to a common housing.

9. (canceled)

10. The sample preparation cartridge of claim 1 wherein the first moveable arm and the second moveable arm are configured to rotate around a common axis.

11. The sample preparation cartridge of claim 10 wherein the first moveable arm and the second moveable arm are fixed relative to each other and configured to be rotatable relative to the plurality of containers.

12. (canceled)

13. The sample preparation cartridge of claim 1 wherein the first moveable arm and the second moveable arm are configured to be rotated and/or operated at least one of (i) independently from one another, (ii) simultaneously, (iii) in parallel, or (iv) in series.

14-37. (canceled)

38. The sample preparation cartridge of claim 1 wherein each moveable arm comprises:
a cavity configured to support fluid, and
a receiving portion, coupled to the cavity, configured to receive fluid from a container into the cavity, or dispense fluid from the cavity into a container.

39. The sample preparation cartridge of claim 38 wherein at least one container comprises an engagement portion configured to reversibly engage with the receiving portion of the movable arm.

40. The sample preparation cartridge of claim 39 wherein each moveable arm is configured to be moved between:
an engaged configuration, wherein the moveable arm is in sealed engagement with the engagement portion of a container; and
a displaced configuration, wherein the moveable arm is vertically displaced from the plurality of containers.

41. The sample preparation cartridge of claim 39 wherein the engagement portion comprises a first tubular member configured to extend into the at least one container.

42. The sample preparation cartridge of claim 41 wherein fluid is configured to be drawn from the at least one container through the first tubular member and into the cavity of the first or second moveable arm by aspiration.

43. The sample preparation cartridge of claim 1 wherein each moveable arm comprises a pipette.

44. The sample preparation cartridge of claim 43, wherein the first tubular member comprises a pipette tip; and
wherein the receiving portion of the at least one moveable arm comprises a second tubular member;
wherein in the engaged configuration the second tubular member is in sealed engagement with the pipette tip.

45. The sample preparation cartridge of claim 44 wherein at least one of (i) the second tubular member and (ii) the cavity may be detachable from each moveable arm such that the at least one of (i) the second tubular member and (ii) the cavity may be replaceable.

46-60. (canceled)

61. The sample preparation cartridge of claim 1 wherein the plurality of containers comprises at least one removable container configured to be detachable from the cartridge.

62. The sample preparation cartridge of claim 61 wherein the at least one removable container comprises a sealing member configured to seal the removable container when detached from the cartridge.

63. The sample preparation cartridge of claim 62 wherein the cartridge comprises a second sealing member configured to seal the cartridge when the at least one removable container is detached.

64-74. (canceled)
